(19) United States
(12) Patent Application Publication
(10) Pub. No.: US 2026/0254940 A1
(43) Pub. Date: Aug. 27, 2026

(54) VIDEO SIGNAL PROCESSING METHOD AND DEVICE THEREFOR

(71) Applicant: WILUS INSTITUTE OF STANDARDS AND TECHNOLOGY INC., Gyeonggi-do (KR)

(72) Inventors: Dongcheol KIM, Gyeonggi-do (KR); Kyungyong KIM, Gyeonggi-do (KR); Juhyung SON, Gyeonggi-do (KR); Jinsam KWAK, Gyeonggi-do (KR)

(73) Assignee: WILUS INSTITUTE OF STANDARDS AND TECHNOLOGY INC., Gyeonggi-do (KR)

(21) Appl. No.: 18/707,380

(22) PCT Filed: Nov. 3, 2022
(86) PCT No.: PCT/KR2022/017179

§ 371 Date: May 14, 2026

(30) Foreign Application Priority Data
Nov. 3, 2021 (KR) 10-2021-0149642
Nov. 22, 2021 (KR) 10-2021-0161269
Dec. 17, 2021 (KR) 10-2021-0181368
Apr. 12, 2022 (KR) 10-2022-0045415

(51) Int. Cl. H04N 19/105; H04N 19/176; H04N 19/18; H04N 19/70

(52) U.S. Cl. CPC H04N 19/105; H04N 19/176; H04N 19/18; H04N 19/70

(57) ABSTRACT

A device for decoding a video signal comprises a processor. The processor configures a transform kernel set including one or more transform kernels. The one or more transform kernels in the transform kernel set are grouped into a plurality of subgroups. Each of the plurality of subgroups includes the one or more transform kernels. One subgroup is selected from among the plurality of subgroups. A current block is reconstructed on the basis of a transform kernel in the one selected subgroup.

### CROSS-REFERENCE TO RELATED APPLICATIONS

This application is the U.S. National Phase filing under U.S.C. 371 of PCT Patent Application No. PCT/KR2022/017179, filed on Aug. 3, 2022, which claims the benefit of KR Provisional Application No. 10-2021-0149642, filed on Nov. 3, 2021, KR Provisional Application No. 10-2021-0161269, filed on Nov. 22, 2021, KR Provisional Application No. 10-2021-0181368, filed on Dec. 17, 2021, and KR Provisional Application No. 10-2022-0045415, filed on Apr. 12, 2021, the contents of which are all hereby incorporated by reference herein in their entireties.

### TECHNICAL FIELD

The present disclosure relates to a video signal processing method and device and, more specifically, to a video signal processing method and device by which a video signal is encoded or decoded.

### BACKGROUND ART

Compression coding refers to a series of signal processing techniques for transmitting digitized information through a communication line or storing information in a form suitable for a storage medium. An object of compression encoding includes objects such as voice, video, and text, and in particular, a technique for performing compression encoding on an image is referred to as video compression. Compression coding for a video signal is performed by removing excess information in consideration of spatial correlation, temporal correlation, and stochastic correlation. However, with the recent development of various media and data transmission media, a more efficient video signal processing method and apparatus are required.

### DISCLOSURE OF INVENTION

### Technical Problem

An aspect of the present specification is to provide a video signal processing method and a device therefor to increase the coding efficiency of a video signal.

### Solution to Problem

The present specification provides a method for processing video signals and a device therefor.

In the present specification, a video signal decoding device may include a processor, wherein the processor is configured to construct a transform kernel set including one or more transform kernels, the one or more transform kernels in the transform kernel set are grouped into multiple sub-groups, each of the multiple sub-groups includes the one or more transform kernels, one sub-group is selected from the multiple sub-groups, and a current block is reconstructed on the basis of a transform kernel in the selected one sub-group.

The processor may determine whether or not to predict signs of transform coefficients of the current block on the basis of the result of parsing a first syntax element included in a sequence parameter set, and if the parsing result indicates that signs of transform coefficients of the current block are to be predicted, the current block may be reconstructed on the basis of the predicted signs and a transform kernel in selected one sub-group.

In addition, in the present specification, a video signal encoding device may include a processor, and the processor may acquire a bitstream decoded by a decoding method. In addition, the present specification includes a computer-readable non-transitory storage medium configured to store the bitstream.

The decoding method may include: constructing a transform kernel set including one or more transform kernels, the one or more transform kernels in the transform kernel set being grouped into multiple sub-groups, each of the multiple sub-groups including the one or more transform kernels; selecting one sub-group from the multiple sub-groups; and reconstructing a current block on the basis of a transform kernel in the selected one sub-group.

The decoding method may further include determining whether or not to predict signs of transform coefficients of the current block on the basis of the result of parsing a first syntax element included in a sequence parameter set, and if the parsing result indicates that signs of transform coefficients of the current block are to be predicted, the current block may be reconstructed on the basis of the predicted signs and a transform kernel in selected one sub-group.

The one sub-group may be selected on the basis of a parameter related to a residual signal of the current block.

The parameter related to the residual signal may be determined on the basis of the sum of transform coefficients of the current block.

The parameter related to the residual signal may be determined on the basis of the position of a transform coefficient scanned last according to a scan order among transform coefficients of the current block.

The parameter related to the residual signal may be determined on the basis of the sum of quantization parameters of transform coefficients of the current block.

The parameter related to the residual signal may be determined on the basis of the distribution of quantization level signals of transform coefficients of the current block.

The distribution of quantization level signals may be determined on the basis of at least one of the deviation, average, and variance of transform coefficients of the current block.

The current block may be reconstructed on the basis of a transform kernel corresponding to the smallest cost among costs regarding one or more transform kernels, respectively, in the selected one sub-group, and the cost may be a value related to the degree of similarity between the current block and a reconstructed signal which is reconstructed by using each of one or more transform kernels in the one sub-group.

The one or more transform kernels may be kernels for low frequency non-separable transform (LFNST).

A scan method for an input vector for the LFNST may be determined on the basis of a prediction mode of the current block.

The scan method may be one of horizontal scan, vertical scan, and diagonal scan.

A scan method for predicting signs of transform coefficients of the current block may be one of horizontal scan, vertical scan, and diagonal scan.

The value of the first syntax element may be constrained by a second syntax element which is a general constraint information (GCI) syntax element, if the second syntax element has a value of 1, the value of the first syntax element may be configured as 0, which indicates that sign prediction regarding transform coefficients of the current block is not to be performed, regardless of the result of parsing the first syntax element, and if the second syntax element has a value of 0, the value of the first syntax element may not be constrained.

### Advantageous Effects of Invention

The present disclosure provides a method for efficiently processing a video signal.

The effects obtainable from the present specification are not limited to the effects mentioned above, and other effects not mentioned may be clearly understood by to those skilled in the art, to which the present disclosure belongs, from the description below.

### BRIEF DESCRIPTION OF DRAWINGS

FIG. 1 is a schematic block diagram of a video signal encoding apparatus according to an embodiment of the present invention.

FIG. 2 is a schematic block diagram of a video signal decoding apparatus according to an embodiment of the present invention.

FIG. 3 shows an embodiment in which a coding tree unit is divided into coding units in a picture.

FIG. 4 shows an embodiment of a method for signaling a division of a quad tree and a multi-type tree.

FIGS. 5 and 6 illustrate an intra-prediction method in more detail according to an embodiment of the present disclosure.

FIG. 7 illustrates the position of neighboring blocks used to construct a motion candidate list in inter prediction.

FIG. 8 illustrates the type of transform kernels according to an embodiment of the present specification.

FIG. 9 illustrate the 0^{th} (the lowest frequency component of the corresponding transform kernel) basis function of DCT-II, DCT-V, DCT-VIII, DST-I, and DST-VII transforms according to an embodiment of the present specification.

FIG. 10 and FIG. 11 illustrate transform kernel sets according to an embodiment of the present specification.

FIG. 12 illustrates a transform kernel set grouping method according to an embodiment of the present specification.

FIG. 13 illustrates remapping of indices in a transform kernel set according to an embodiment of the present specification.

FIG. 14 illustrates a transform kernel set according to an embodiment of the present specification.

FIG. 15 illustrates a syntax structure including a kernel indicator related to MTS according to an embodiment of the present specification.

FIG. 16 illustrates a method in which an inverse transform unit of a video signal processing device transforms the current block without separate signaling.

FIG. 17 and FIG. 18 illustrate a cost calculation method according to an embodiment of the present specification.

FIG. 19 illustrates the structure of truncated unary binarization according to an embodiment of the present specification.

FIG. 20 illustrates context coding and context modeling according to an embodiment of the present specification.

FIG. 21 illustrates a residual signal reconstruction process according to an embodiment of the present specification.

FIG. 22 illustrates the ROI of blocks to which secondary transform is applied according to an embodiment of the present specification.

FIG. 23 illustrates a method for applying secondary transform (LFNST) according to an embodiment of the present specification.

FIG. 24 and FIG. 25 illustrate a mapping relation between intra prediction modes and transform kernel sets for secondary transform according to an embodiment of the present specification.

FIG. 26 illustrates a relation between a secondary transform's input vector and an intra prediction mode.

FIG. 27 to FIG. 30 illustrate a method for constructing an input vector of secondary transform according to an embodiment of the present specification.

FIG. 31 illustrates a method for applying secondary transform regarding a transform block to each sub-block according to an embodiment of the present specification.

FIG. 32 illustrates a method for scanning quantized transform coefficients and a method for entropy-coding syntax elements related to the quantized transform coefficients according to an embodiment of the present specification.

FIG. 33 illustrates an entropy coding unit of a video signal processing device according to an embodiment of the present specification.

FIG. 34 illustrates a method for predicting the sign of a quantized transform coefficient.

FIG. 35 illustrates a cost calculating method according to an embodiment of the present specification.

FIG. 36 illustrates a scan method for predicting the sign of a quantized transform coefficient according to an embodiment of the present specification.

FIG. 37 illustrates a method for configuring an area for sign prediction of a quantized transform coefficient in connection with a block to which sub-block transform is applied according to an embodiment of the present specification.

FIG. 38 illustrates the structure of a high-level syntax according to an embodiment of the present specification.

FIG. 39 illustrates a context model regarding syntax elements related to transform coefficient signs of the present specification.

FIG. 40 illustrates a video signal processing method according to an embodiment of the present specification.

### BEST MODE FOR CARRYING OUT THE INVENTION

Terms used in this specification may be currently widely used general terms in consideration of functions in the present invention but may vary according to the intents of those skilled in the art, customs, or the advent of new technology. Additionally, in certain cases, there may be terms the applicant selects arbitrarily and in this case, their meanings are described in a corresponding description part of the present invention. Accordingly, terms used in this specification should be interpreted based on the substantial meanings of the terms and contents over the whole specification.

In this specification, ‘A and/or B’ may be interpreted as meaning ‘including at least one of A or B.’

In this specification, some terms may be interpreted as follows. Coding may be interpreted as encoding or decoding in some cases. In the present specification, an apparatus for generating a video signal bitstream by performing encoding (coding) of a video signal is referred to as an encoding apparatus or an encoder, and an apparatus that performs decoding (decoding) of a video signal bitstream to reconstruct a video signal is referred to as a decoding apparatus or decoder. In addition, in this specification, the video signal processing apparatus is used as a term of a concept including both an encoder and a decoder. Information is a term including all values, parameters, coefficients, elements, etc. In some cases, the meaning is interpreted differently, so the present invention is not limited thereto. ‘Unit’ is used as a meaning to refer to a basic unit of image processing or a specific position of a picture, and refers to an image region including both a luma component and a chroma component. Furthermore, a “block” refers to a region of an image that includes a particular component of a luma component and chroma components (i.e., Cb and Cr). However, depending on the embodiment, the terms “unit”, “block”, “partition”, “signal”, and “region” may be used interchangeably. Also, in the present specification, the term “current block” refers to a block that is currently scheduled to be encoded, and the term “reference block” refers to a block that has already been encoded or decoded and is used as a reference in a current block. In addition, the terms “luma”, “luminance”, “Y”, and the like may be used interchangeably in this specification. Additionally, in the present specification, the terms “chroma”, “chrominance”, “Cb or Cr”, and the like may be used interchangeably, and chroma components are classified into two components, Cb and Cr, and thus each chroma component may be distinguished and used. Additionally, in the present specification, the term “unit” may be used as a concept that includes a coding unit, a prediction unit, and a transform unit. A “picture” refers to a field or a frame, and depending on embodiments, the terms may be used interchangeably. Specifically, when a captured video is an interlaced video, a single frame may be separated into an odd (or cardinal or top) field and an even (or even-numbered or bottom) field, and each field may be configured in one picture unit and encoded or decoded. If the captured video is a progressive video, a single frame may be configured as a picture and encoded or decoded. In addition, in the present specification, the terms “error signal”, “residual signal”, “residue signal”, “remaining signal”, and “difference signal” may be used interchangeably. Also, in the present specification, the terms “intra-prediction mode”, “intra-prediction directional mode”, “intra-picture prediction mode”, and “intra-picture prediction directional mode” may be used interchangeably. In addition, in the present specification, the terms “motion”, “movement”, and the like may be used interchangeably. Also, in the present specification, the terms “left”, “left above”, “above”, “right above”, “right”, “right below”, “below”, and “left below” may be used interchangeably with “leftmost”, “top left”, “top”, “top right”, “right”, “bottom right”, “bottom”, and “bottom left”. Also, the terms “element” and “member” may be used interchangeably. Picture order count (POC) represents temporal position information of pictures (or frames), and may be the playback order in which displaying is performed on a screen, and each picture may have unique POC.

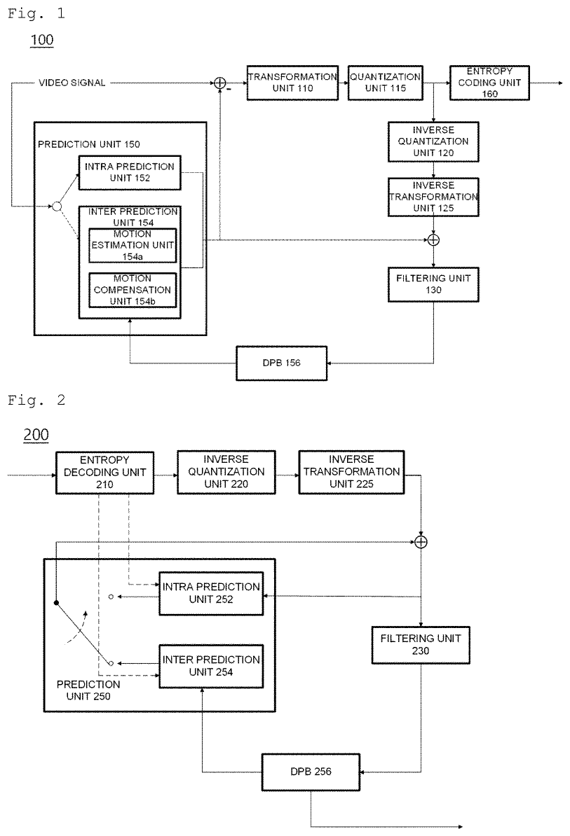

FIG. 1 is a schematic block diagram of a video signal encoding apparatus according to an embodiment of the present invention. Referring to FIG. 1, the encoding apparatus 100 of the present invention includes a transformation unit 110, a quantization unit 115, an inverse quantization unit 120, an inverse transformation unit 125, a filtering unit 130, a prediction unit 150, and an entropy coding unit 160.

The transformation unit 110 obtains a value of a transform coefficient by transforming a residual signal, which is a difference between the inputted video signal and the predicted signal generated by the prediction unit 150. For example, a Discrete Cosine Transform (DCT), a Discrete Sine Transform (DST), or a Wavelet Transform can be used. The DCT and DST perform transformation by splitting the input picture signal into blocks. In the transformation, coding efficiency may vary according to the distribution and characteristics of values in the transformation region. A transform kernel used for the transform of a residual block may has characteristics that allow a vertical transform and a horizontal transform to be separable. In this case, the transform of the residual block may be performed separately as a vertical transform and a horizontal transform. For example, an encoder may perform a vertical transform by applying a transform kernel in the vertical direction of a residual block. In addition, the encoder may perform a horizontal transform by applying the transform kernel in the horizontal direction of the residual block. In the present disclosure, the transform kernel may be used to refer to a set of parameters used for the transform of a residual signal, such as a transform matrix, a transform array, a transform function, or transform. For example, a transform kernel may be any one of multiple available kernels. Also, transform kernels based on different transform types may be used for the vertical transform and the horizontal transform, respectively.

The transform coefficients are distributed with higher coefficients toward the top left of a block and coefficients closer to “0” toward the bottom right of the block. As the size of a current block increases, there are likely to be many coefficients of “0” in the bottom-right region of the block. To reduce the transform complexity of a large-sized block, only a random top-left region may be kept and the remaining region may be reset to “0”.

In addition, error signals may be present in only some regions of a coding block. In this case, the transform process may be performed on only some random regions. In an embodiment, in a block having a size of 2N×2N, an error signal may be present only in the first 2N×N block, and the transform process may be performed on the first 2N×N block. However, the second 2N×N block may not be transformed and may not be encoded or decoded. Here, N may be any positive integer.

The encoder may perform an additional transform before transform coefficients are quantized. The above-described transform method may be referred to as a primary transform, and the additional transform may be referred to as a secondary transform. The secondary transform may be selective for each residual block. According to an embodiment, the encoder may improve coding efficiency by performing a secondary transform for regions where it is difficult to focus energy in a low-frequency region by using a primary transform alone. For example, a secondary transform may be additionally performed for blocks where residual values appear large in directions other than the horizontal or vertical direction of a residual block. Unlike a primary transform, a secondary transform may not be performed separately as a vertical transform and a horizontal transform. Such a secondary transform may be referred to as a low frequency non-separable transform (LFNST).

The quantization unit 115 quantizes the value of the transform coefficient value outputted from the transformation unit 110.

In order to improve coding efficiency, instead of coding the picture signal as it is, a method of predicting a picture using a region already coded through the prediction unit 150 and obtaining a reconstructed picture by adding a residual value between the original picture and the predicted picture to the predicted picture is used. In order to prevent mismatches in the encoder and decoder, information that can be used in the decoder should be used when performing prediction in the encoder. For this, the encoder performs a process of reconstructing the encoded current block again. The inverse quantization unit 120 inverse-quantizes the value of the transform coefficient, and the inverse transformation unit 125 reconstructs the residual value using the inverse quantized transform coefficient value. Meanwhile, the filtering unit 130 performs filtering operations to improve the quality of the reconstructed picture and to improve the coding efficiency. For example, a deblocking filter, a sample adaptive offset (SAO), and an adaptive loop filter may be included. The filtered picture is outputted or stored in a decoded picture buffer (DPB) 156 for use as a reference picture.

The deblocking filter is a filter for removing intra-block distortions generated at the boundaries between blocks in a reconstructed picture. Through the distribution of pixels included in several columns or rows based on random edges in a block, the encoder may determine whether to apply a deblocking filter to the edges. When applying a deblocking filter to the block, the encoder may apply a long filter, a strong filter, or a weak filter depending on the strength of deblocking filtering. Additionally, horizontal filtering and vertical filtering may be processed in parallel. The sample adaptive offset (SAO) may be used to correct offsets from an original video on a pixel-by-pixel basis with respect to a residual block to which a deblocking filter has been applied. To correct offset for a particular picture, the encoder may use a technique that divides pixels included in the picture into a predetermined number of regions, determines a region in which the offset correction is to be performed, and applies the offset to the region (Band Offset). Alternatively, the encoder may use a method for applying an offset in consideration of edge information of each pixel (Edge Offset). The adaptive loop filter (ALF) is a technique of dividing pixels included in a video into predetermined groups and then determining one filter to be applied to each group, thereby performing filtering differently for each group. Information about whether to apply ALF may be signaled on a per-coding unit basis, and the shape and filter coefficients of an ALF to be applied may vary for each block. In addition, an ALF filter having the same shape (a fixed shape) may be applied regardless of the characteristics of a target block to which the ALF filter is to be applied.

The prediction unit 150 includes an intra-prediction unit 152 and an inter-prediction unit 154. The intra-prediction unit 152 performs intra prediction within a current picture, and the inter-prediction unit 154 performs inter prediction to predict the current picture by using a reference picture stored in the decoded picture buffer 156. The intra-prediction unit 152 performs intra prediction from reconstructed regions in the current picture and transmits intra encoding information to the entropy coding unit 160. The intra encoding information may include at least one of an intra-prediction mode, a most probable mode (MPM) flag, an MPM index, and information regarding a reference sample. The inter-prediction unit 154 may again include a motion estimation unit 154a and a motion compensation unit 154b. The motion estimation unit 154a finds a part most similar to a current region with reference to a specific region of a reconstructed reference picture, and obtains a motion vector value which is the distance between the regions. Reference region-related motion information (reference direction indication information (L0 prediction, L1 prediction, or bidirectional prediction), a reference picture index, motion vector information, etc.) and the like, obtained by the motion estimation unit 154a, are transmitted to the entropy coding unit 160 so as to be included in a bitstream. The motion compensation unit 154B performs inter-motion compensation by using the motion information transmitted by the motion estimation unit 154a, to generate a prediction block for the current block. The inter-prediction unit 154 transmits the inter encoding information, which includes motion information related to the reference region, to the entropy coding unit 160.

According to an additional embodiment, the prediction unit 150 may include an intra block copy (IBC) prediction unit (not shown). The IBC prediction unit performs IBC prediction from reconstructed samples in a current picture and transmits IBC encoding information to the entropy coding unit 160. The IBC prediction unit references a specific region within a current picture to obtain a block vector value that indicates a reference region used to predict a current region. The IBC prediction unit may perform IBC prediction by using the obtained block vector value. The IBC prediction unit transmits the IBC encoding information to the entropy coding unit 160. The IBC encoding information may include at least one of reference region size information and block vector information (index information for predicting the block vector of a current block in a motion candidate list, and block vector difference information).

When the above picture prediction is performed, the transform unit 110 transforms a residual value between an original picture and a predictive picture to obtain a transform coefficient value. At this time, the transform may be performed on a specific block basis in the picture, and the size of the specific block may vary within a predetermined range. The quantization unit 115 quantizes the transform coefficient value generated by the transform unit 110 and transmits the quantized transform coefficient to the entropy coding unit 160.

The quantized transform coefficients in the form of a two-dimensional array may be rearranged into a one-dimensional array for entropy coding. In relation to methods for scanning a quantized transform coefficient, the size of a transform block and an intra-picture prediction mode may determine which scanning method is used. In an embodiment, diagonal, vertical, and horizontal scans may be applied. This scan information may be signaled on a block-by-block basis, and may be derived based on predetermined rules.

The entropy coding unit 160 generates a video signal bitstream by entropy coding information indicating a quantized transform coefficient, intra encoding information, and inter encoding information. The entropy coding unit 160 may use variable length coding (VLC) and arithmetic coding. The variable length coding (VLC) is a technique of transforming input symbols into consecutive codewords, wherein the length of the codewords is variable. For example, frequently occurring symbols are represented by shorter codewords, while less frequently occurring symbols are represented by longer codewords. As the variable length coding, context-based adaptive variable length coding (CAVLC) may be used. The arithmetic coding uses the probability distribution of each data symbol to transform consecutive data symbols into a single decimal number. The arithmetic coding allows acquisition of the optimal decimal bits needed to represent each symbol. As the arithmetic coding, context-based adaptive binary arithmetic coding (CABAC) may be used.

CABAC is a binary arithmetic coding technique using multiple context models generated based on probabilities obtained from experiments. First, when symbols are not in binary form, the encoder binarizes each symbol by using exp-Golomb, etc. The binarized value, 0 or 1, may be described as a bin. A CABAC initialization process is divided into context initialization and arithmetic coding initialization. The context initialization is the process of initializing the probability of occurrence of each symbol, and is determined by the type of symbol, a quantization parameter (QP), and slice type (I, P, or B). A context model having the initialization information may use a probability-based value obtained through an experiment. The context model provides information about the probability of occurrence of Least Probable Symbol (LPS) or Most Probable Symbol (MPS) for a symbol to be currently coded and about which of bin values 0 and 1 corresponds to the MPS (valMPS). One of multiple context models is selected via a context index (ctxIdx), and the context index may be derived from information in a current block to be encoded or from information about neighboring blocks. Initialization for binary arithmetic coding is performed based on a probability model selected from the context models. In the binary arithmetic coding, encoding is performed through the process in which division into probability intervals is made through the probability of occurrence of 0 and 1, and then a probability interval corresponding to a bin to be processed becomes the entire probability interval for the next bin to be processed. Information about a position within the last bin in which the last bin has been processed is output. However, the probability interval cannot be divided indefinitely, and thus, when the probability interval is reduced to a certain size, a renormalization process is performed to widen the probability interval and the corresponding position information is output. In addition, after each bin is processed, a probability update process may be performed, wherein information about a processed bin is used to set a new probability for the next to be processed.

The generated bitstream is encapsulated in network abstraction layer (NAL) unit as basic units. The NAL units are classified into video a coding layer (VCL) NAL unit, which includes video data, and a non-VCL NAL unit, which includes parameter information for decoding video data. There are various types of VCL or non-VCL NAL units. A NAL unit includes NAL header information and raw byte sequence payload (RBSP) which is data. The NAL header information includes summary information about the RBSP. The RBSP of a VCL NAL unit includes an integer number of encoded coding tree units. In order to decode a bitstream in a video decoder, it is necessary to separate the bitstream into NAL units and then decode each of the separate NAL units. Information required for decoding a video signal bitstream may be included in a picture parameter set (PPS), a sequence parameter set (SPS), a video parameter set (VPS), etc., and transmitted.

The block diagram of FIG. 1 illustrates the encoding device 100 according to an embodiment of the present disclosure, wherein the separately shown blocks logically distinguish the elements of the encoding device 100. Accordingly, the above-described elements of the encoding device 100 may be mounted as a single chip or multiple chips, depending on the design of the device. According to an embodiment, the above-described operation of each element of the encoding device 100 may be performed by a processor (not shown).

FIG. 2 is a schematic block diagram of a video signal decoding apparatus 200 according to an embodiment of the present invention. Referring to FIG. 2, the decoding apparatus 200 of the present invention includes an entropy decoding unit 210, an inverse quantization unit 220, an inverse transformation unit 225, a filtering unit 230, and a prediction unit 250.

The entropy decoding unit 210 entropy-decodes a video signal bitstream to extract transform coefficient information, intra encoding information, inter encoding information, and the like for each region. For example, the entropy decoding unit 210 may obtain a binarization code for transform coefficient information of a specific region from the video signal bitstream. The entropy decoding unit 210 obtains a quantized transform coefficient by inverse-binarizing a binary code. The inverse quantization unit 220 inverse-quantizes the quantized transform coefficient, and the inverse transformation unit 225 reconstructs a residual value by using the inverse-quantized transform coefficient. The video signal processing device 200 reconstructs an original pixel value by summing the residual value obtained by the inverse transformation unit 225 with a prediction value obtained by the prediction unit 250.

Meanwhile, the filtering unit 230 performs filtering on a picture to improve image quality. This may include a deblocking filter for reducing block distortion and/or an adaptive loop filter for removing distortion of the entire picture. The filtered picture is outputted or stored in the DPB 256 for use as a reference picture for the next picture.

The prediction unit 250 includes an intra prediction unit 252 and an inter prediction unit 254. The prediction unit 250 generates a prediction picture by using the encoding type decoded through the entropy decoding unit 210 described above, transform coefficients for each region, and intra/inter encoding information. In order to reconstruct a current block in which decoding is performed, a decoded region of the current picture or other pictures including the current block may be used. In a reconstruction, only a current picture, that is, a picture (or, tile/slice) that performs intra prediction or intra BC prediction, is called an intra picture or an I picture (or, tile/slice), and a picture (or, tile/slice) that can perform all of intra prediction, inter prediction, and intra BC prediction is called an inter picture (or, tile/slice). In order to predict sample values of each block among inter pictures (or, tiles/slices), a picture (or, tile/slice) using up to one motion vector and a reference picture index is called a predictive picture or P picture (or, tile/slice), and a picture (or tile/slice) using up to two motion vectors and a reference picture index is called a bi-predictive picture or a B picture (or tile/slice). In other words, the P picture (or, tile/slice) uses up to one motion information set to predict each block, and the B picture (or, tile/slice) uses up to two motion information sets to predict each block. Here, the motion information set includes one or more motion vectors and one reference picture index.

The intra prediction unit 252 generates a prediction block using the intra encoding information and reconstructed samples in the current picture. As described above, the intra encoding information may include at least one of an intra prediction mode, a Most Probable Mode (MPM) flag, and an MPM index. The intra prediction unit 252 predicts the sample values of the current block by using the reconstructed samples located on the left and/or upper side of the current block as reference samples. In this disclosure, reconstructed samples, reference samples, and samples of the current block may represent pixels. Also, sample values may represent pixel values.

According to an embodiment, the reference samples may be samples included in a neighboring block of the current block. For example, the reference samples may be samples adjacent to a left boundary of the current block and/or samples may be samples adjacent to an upper boundary. Also, the reference samples may be samples located on a line within a predetermined distance from the left boundary of the current block and/or samples located on a line within a predetermined distance from the upper boundary of the current block among the samples of neighboring blocks of the current block. In this case, the neighboring block of the current block may include the left (L) block, the upper (A) block, the below left (BL) block, the above right (AR) block, or the above left (AL) block.

The inter prediction unit 254 generates a prediction block using reference pictures and inter encoding information stored in the DPB 256. The inter coding information may include motion information set (reference picture index, motion vector information, etc.) of the current block for the reference block. Inter prediction may include L0 prediction, L1 prediction, and bi-prediction. L0 prediction means prediction using one reference picture included in the L0 picture list, and L1 prediction means prediction using one reference picture included in the L1 picture list. For this, one set of motion information (e.g., motion vector and reference picture index) may be required. In the bi-prediction method, up to two reference regions may be used, and the two reference regions may exist in the same reference picture or may exist in different pictures. That is, in the bi-prediction method, up to two sets of motion information (e.g., a motion vector and a reference picture index) may be used and two motion vectors may correspond to the same reference picture index or different reference picture indexes. In this case, the reference pictures are pictures located temporally before or after the current picture, and may be pictures for which reconstruction has already been completed. According to an embodiment, two reference regions used in the bi-prediction scheme may be regions selected from picture list L0 and picture list L1, respectively.

The inter prediction unit 254 may obtain a reference block of the current block using a motion vector and a reference picture index. The reference block is in a reference picture corresponding to a reference picture index. Also, a sample value of a block specified by a motion vector or an interpolated value thereof can be used as a predictor of the current block. For motion prediction with sub-pel unit pixel accuracy, for example, an 8-tap interpolation filter for a luma signal and a 4-tap interpolation filter for a chroma signal can be used. However, the interpolation filter for motion prediction in sub-pel units is not limited thereto. In this way, the inter prediction unit 254 performs motion compensation to predict the texture of the current unit from motion pictures reconstructed previously. In this case, the inter prediction unit may use a motion information set.

According to an additional embodiment, the prediction unit 250 may include an IBC prediction unit (not shown). The IBC prediction unit may reconstruct the current region by referring to a specific region including reconstructed samples in the current picture. The IBC prediction unit obtains IBC encoding information for the current region from the entropy decoding unit 210. The IBC prediction unit obtains a block vector value of the current region indicating the specific region in the current picture. The IBC prediction unit may perform IBC prediction by using the obtained block vector value. The IBC encoding information may include block vector information.

The reconstructed video picture is generated by adding the predict value outputted from the intra prediction unit 252 or the inter prediction unit 254 and the residual value outputted from the inverse transformation unit 225. That is, the video signal decoding apparatus 200 reconstructs the current block using the prediction block generated by the prediction unit 250 and the residual obtained from the inverse transformation unit 225.

Meanwhile, the block diagram of FIG. 2 shows a decoding apparatus 200 according to an embodiment of the present invention, and separately displayed blocks logically distinguish and show the elements of the decoding apparatus 200. Accordingly, the elements of the above-described decoding apparatus 200 may be mounted as one chip or as a plurality of chips depending on the design of the device. According to an embodiment, the operation of each element of the above-described decoding apparatus 200 may be performed by a processor (not shown).

The technology proposed in the present specification may be applied to a method and a device for both an encoder and a decoder, and the wording signaling and parsing may be for convenience of description. In general, signaling may be described as encoding each type of syntax from the perspective of the encoder, and parsing may be described as interpreting each type of syntax from the perspective of the decoder. In other words, each type of syntax may be included in a bitstream and signaled by the encoder, and the decoder may parse the syntax and use the syntax in a reconstruction process. In this case, the sequence of bits for each type of syntax arranged according to a prescribed hierarchical configuration may be called a bitstream.

One picture may be partitioned into sub-pictures, slices, tiles, etc. and encoded. A sub-picture may include one or more slices or tiles. When one picture is partitioned into multiple slices or tiles and encoded, all the slices or tiles within the picture must be decoded before the picture can be output a screen. On the other hand, when one picture is encoded into multiple subpictures, only a random subpicture may be decoded and output on the screen. A slice may include multiple tiles or subpictures. Alternatively, a tile may include multiple subpictures or slices. Subpictures, slices, and tiles may be encoded or decoded independently of each other, and thus are advantageous for parallel processing and processing speed improvement. However, there is the disadvantage in that a bit rate increases because encoded information of other adjacent subpictures, slices, and tiles is not available. A subpicture, a slice, and a tile may be partitioned into multiple coding tree units (CTUs) and encoded.

FIG. 3 illustrates an embodiment in which a coding tree unit (CTU) is divided into coding units (CUs) within a picture. In the process of coding a video signal, a picture may be divided into a sequence of coding tree units (CTUs). A coding tree unit may include a luma Coding Tree Block (CTB), two chroma coding tree blocks, and encoded syntax information thereof. One coding tree unit may include one coding unit, or one coding tree unit may be divided into multiple coding units. One coding unit may include a luma coding block (CB), two chroma coding blocks, and encoded syntax information thereof. One coding block may be partitioned into multiple sub-coding blocks. One coding unit may include one transform unit (TU), or one coding unit may be partitioned into multiple transform units. A transform unit may include a luma transform block (TB), two chroma transform blocks, and encoded syntax information thereof. A coding tree unit may be partitioned into multiple coding units. A coding tree unit may become a leaf node without being partitioned. In this case, the coding tree unit itself may be a coding unit.

The coding unit refers to a basic unit for processing a picture in the process of processing the video signal described above, that is, intra/inter prediction, transformation, quantization, and/or entropy coding. The size and shape of the coding unit in one picture may not be constant. The coding unit may have a square or rectangular shape. The rectangular coding unit (or rectangular block) includes a vertical coding unit (or vertical block) and a horizontal coding unit (or horizontal block). In the present specification, the vertical block is a block whose height is greater than the width, and the horizontal block is a block whose width is greater than the height. Further, in this specification, a non-square block may refer to a rectangular block, but the present invention is not limited thereto.

Referring to FIG. 3, the coding tree unit is first split into a quad tree (QT) structure. That is, one node having a 2N×2N size in a quad tree structure may be split into four nodes having an N×N size. In the present specification, the quad tree may also be referred to as a quaternary tree. Quad tree split can be performed recursively, and not all nodes need to be split with the same depth.

Meanwhile, the leaf node of the above-described quad tree may be further split into a multi-type tree (MTT) structure. According to an embodiment of the present invention, in a multi-type tree structure, one node may be split into a binary or ternary tree structure of horizontal or vertical division. That is, in the multi-type tree structure, there are four split structures such as vertical binary split, horizontal binary split, vertical ternary split, and horizontal ternary split. According to an embodiment of the present invention, in each of the tree structures, the width and height of the nodes may all have powers of 2. For example, in a binary tree (BT) structure, a node of a 2N×2N size may be split into two N×2N nodes by vertical binary split, and split into two 2N×N nodes by horizontal binary split. In addition, in a ternary tree (TT) structure, a node of a 2N×2N size is split into (N/2)×2N, N×2N, and (N/2)×2N nodes by vertical ternary split, and split into 2N×(N/2), 2N×N, and 2N×(N/2) nodes by horizontal ternary split. This multi-type tree split can be performed recursively.

A leaf node of the multi-type tree can be a coding unit. When the coding unit is not greater than the maximum transform length, the coding unit can be used as a unit of prediction and/or transform without further splitting. As an embodiment, when the width or height of the current coding unit is greater than the maximum transform length, the current coding unit can be split into a plurality of transform units without explicit signaling regarding splitting. On the other hand, at least one of the following parameters in the above-described quad tree and multi-type tree may be predefined or transmitted through a higher level set of RBSPs such as PPS, SPS, VPS, and the like. 1) CTU size: root node size of quad tree, 2) minimum QT size MinQtSize: minimum allowed QT leaf node size, 3) maximum BT size MaxBtSize: maximum allowed BT root node size, 4) Maximum TT size MaxTtSize: maximum allowed TT root node size, 5) Maximum MTT depth MaxMttDepth: maximum allowed depth of MTT split from QT's leaf node, 6) Minimum BT size MinBtSize: minimum allowed BT leaf node size, 7) Minimum TT size MinTtSize: minimum allowed TT leaf node size.

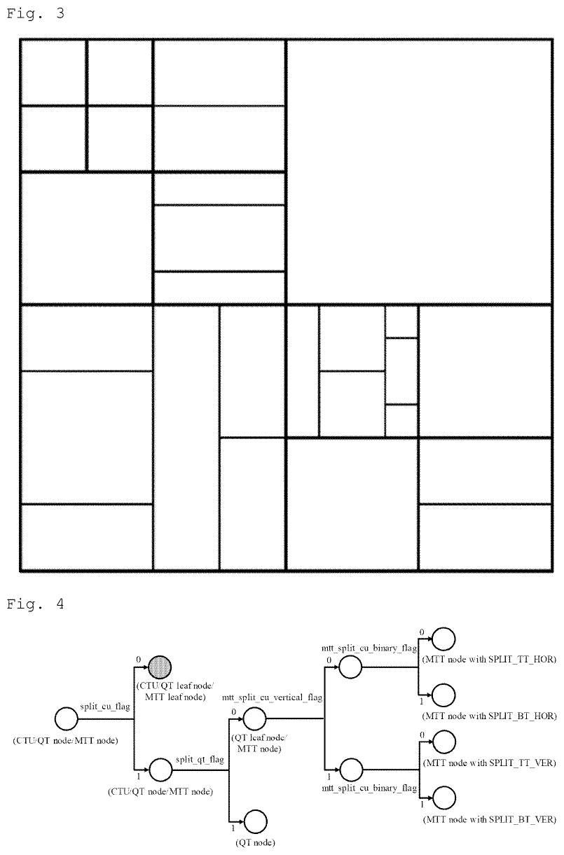

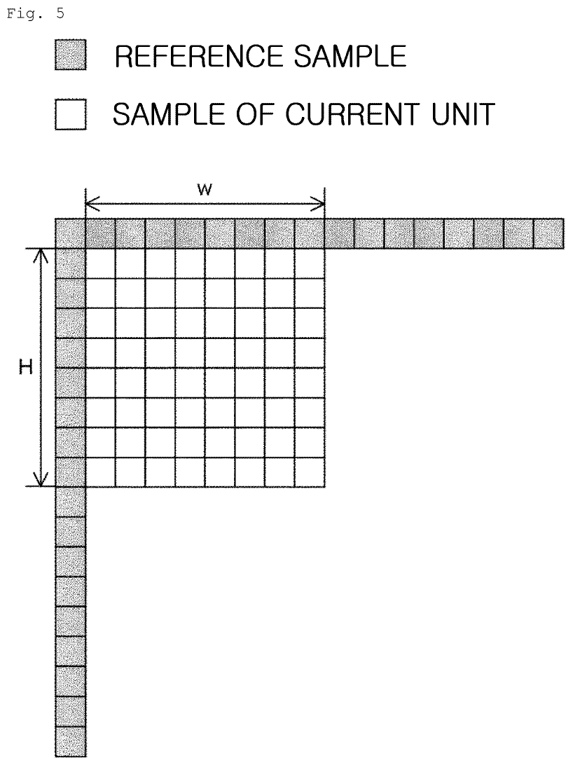

FIG. 4 illustrates an embodiment of a method of signaling splitting of the quad tree and multi-type tree. Preset flags can be used to signal the splitting of the quad tree and multi-type tree described above. Referring to FIG. 4, at least one of a flag ‘split_cu_flag’ indicating whether or not to split a node, a flag ‘split_qt_flag’ indicating whether or not to split a quad tree node, a flag ‘mtt_split_cu_vertical_flag’ indicating a splitting direction of the multi-type tree node, or a flag ‘mtt_split_cu_binary_flag’ indicating a splitting shape of the multi-type tree node can be used.

According to an embodiment of the present invention, ‘split_cu_flag’, which is a flag indicating whether or not to split the current node, can be signaled first. When the value of ‘split_cu_flag’ is 0, it indicates that the current node is not split, and the current node becomes a coding unit. When the current node is the coating tree unit, the coding tree unit includes one unsplit coding unit. When the current node is a quad tree node ‘QT node’, the current node is a leaf node ‘QT leaf node’ of the quad tree and becomes the coding unit. When the current node is a multi-type tree node ‘MTT node’, the current node is a leaf node ‘MTT leaf node’ of the multi-type tree and becomes the coding unit.

When the value of ‘split_cu_flag’ is 1, the current node can be split into nodes of the quad tree or multi-type tree according to the value of ‘split_qt_flag’. A coding tree unit is a root node of the quad tree, and can be split into a quad tree structure first. In the quad tree structure, ‘split_qt_flag’ is signaled for each node ‘QT node’. When the value of ‘split_qt_flag’ is 1, the corresponding node is split into 4 square nodes, and when the value of ‘qt split flag’ is 0, the corresponding node becomes the ‘QT leaf node’ of the quad tree, and the corresponding node is split into multi-type nodes. According to an embodiment of the present invention, quad tree splitting can be limited according to the type of the current node. Quad tree splitting can be allowed when the current node is the coding tree unit (root node of the quad tree) or the quad tree node, and quad tree splitting may not be allowed when the current node is the multi-type tree node. Each quad tree leaf node ‘QT leaf node’ can be further split into a multi-type tree structure. As described above, when ‘split_qt_flag’ is 0, the current node can be split into multi-type nodes. In order to indicate the splitting direction and the splitting shape, ‘mtt_split_cu_vertical_flag’ and ‘mtt_split_cu_binary_flag’ can be signaled. When the value of ‘mtt_split_cu_vertical_flag’ is 1, vertical splitting of the node ‘MTT node’ is indicated, and when the value of ‘mtt_split_cu_vertical_flag’ is 0, horizontal splitting of the node ‘MTT node’ is indicated. In addition, when the value of ‘mtt_split_cu_binary_flag’ is 1, the node ‘MTT node’ is split into two rectangular nodes, and when the value of ‘mtt_split_cu_binary_flag’ is 0, the node ‘MTT node’ is split into three rectangular nodes.

In the tree partitioning structure, a luma block and a chroma block may be partitioned in the same form. That is, a chroma block may be partitioned by referring to the partitioning form of a luma block. When a current chroma block is less than a predetermined size, a chroma block may not be partitioned even if a luma block is partitioned.

In the tree partitioning structure, a luma block and a chroma block may have different forms. In this case, luma block partitioning information and chroma block partitioning information may be signaled separately. Furthermore, in addition to the partitioning information, luma block encoding information and chroma block encoding information may also be different from each other. In one example, the luma block and the chroma block may be different in at least one among intra encoding mode, encoding information for motion information, etc.

A node to be split into the smallest units may be treated as one coding block. When a current block is a coding block, the coding block may be partitioned into several sub-blocks (sub-coding blocks), and the sub-blocks may have the same prediction information or different pieces of prediction information. In one example, when a coding unit is in an intra mode, intra-prediction modes of sub-blocks may be the same or different from each other. Also, when the coding unit is in an inter mode, sub-blocks may have the same motion information or different pieces of the motion information. Furthermore, the sub-blocks may be encoded or decoded independently of each other. Each sub-block may be distinguished by a sub-block index (sbIdx). Also, when a coding unit is partitioned into sub-blocks, the coding unit may be partitioned horizontally, vertically, or diagonally. In an intra mode, a mode in which a current coding unit is partitioned into two or four sub-blocks horizontally or vertically is called intra sub-partitions (ISP). In an inter mode, a mode in which a current coding block is partitioned diagonally is called a geometric partitioning mode (GPM). In the GPM mode, the position and direction of a diagonal line are derived using a predetermined angle table, and index information of the angle table is signaled.

Picture prediction (motion compensation) for coding is performed on a coding unit that is no longer divided (i.e., a leaf node of a coding unit tree). Hereinafter, the basic unit for performing the prediction will be referred to as a “prediction unit” or a “prediction block”.

Hereinafter, the term “unit” used herein may replace the prediction unit, which is a basic unit for performing prediction. However, the present disclosure is not limited thereto, and “unit” may be understood as a concept broadly encompassing the coding unit.

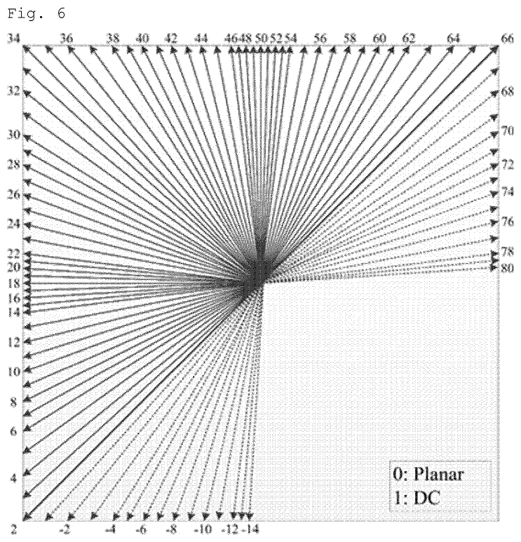

FIGS. 5 and 6 more specifically illustrate an intra prediction method according to an embodiment of the present invention. As described above, the intra prediction unit predicts the sample values of the current block by using the reconstructed samples located on the left and/or upper side of the current block as reference samples.

First, FIG. 5 shows an embodiment of reference samples used for prediction of a current block in an intra prediction mode. According to an embodiment, the reference samples may be samples adjacent to the left boundary of the current block and/or samples adjacent to the upper boundary. As shown in FIG. 5, when the size of the current block is W×H and samples of a single reference line adjacent to the current block are used for intra prediction, reference samples may be configured using a maximum of 2 W+2H+1 neighboring samples located on the left and/or upper side of the current block.

Pixels from multiple reference lines may be used for intra prediction of the current block. The multiple reference lines may include n lines located within a predetermined range from the current block. According to an embodiment, when pixels from multiple reference lines are used for intra prediction, separate index information that indicates lines to be set as reference pixels may be signaled, and may be named a reference line index.

When at least some samples to be used as reference samples have not yet been reconstructed, the intra prediction unit may obtain reference samples by performing a reference sample padding procedure. The intra prediction unit may perform a reference sample filtering procedure to reduce an error in intra prediction. That is, filtering may be performed on neighboring samples and/or reference samples obtained by the reference sample padding procedure, so as to obtain the filtered reference samples. The intra prediction unit predicts samples of the current block by using the reference samples obtained as in the above. The intra prediction unit predicts samples of the current block by using unfiltered reference samples or filtered reference samples. In the present disclosure, neighboring samples may include samples on at least one reference line. For example, the neighboring samples may include adjacent samples on a line adjacent to the boundary of the current block.

Next, FIG. 6 shows an embodiment of prediction modes used for intra prediction. For intra prediction, intra prediction mode information indicating an intra prediction direction may be signaled. The intra prediction mode information indicates one of a plurality of intra prediction modes included in the intra prediction mode set. When the current block is an intra prediction block, the decoder receives intra prediction mode information of the current block from the bitstream. The intra prediction unit of the decoder performs intra prediction on the current block based on the extracted intra prediction mode information.

According to an embodiment of the present invention, the intra prediction mode set may include all intra prediction modes used in intra prediction (e.g., a total of 67 intra prediction modes). More specifically, the intra prediction mode set may include a planar mode, a DC mode, and a plurality (e.g., 65) of angle modes (i.e., directional modes). Each intra prediction mode may be indicated through a preset index (i.e., intra prediction mode index). For example, as shown in FIG. 6, the intra prediction mode index 0 indicates a planar mode, and the intra prediction mode index 1 indicates a DC mode. Also, the intra prediction mode indexes 2 to 66 may indicate different angle modes, respectively. The angle modes respectively indicate angles which are different from each other within a preset angle range. For example, the angle mode may indicate an angle within an angle range (i.e., a first angular range) between 45 degrees and −135 degrees clockwise. The angle mode may be defined based on the 12 o'clock direction. In this case, the intra prediction mode index 2 indicates a horizontal diagonal (HDIA) mode, the intra prediction mode index 18 indicates a horizontal (Horizontal, HOR) mode, the intra prediction mode index 34 indicates a diagonal (DIA) mode, the intra prediction mode index 50 indicates a vertical (VER) mode, and the intra prediction mode index 66 indicates a vertical diagonal (VDIA) mode.

Meanwhile, the preset angle range can be set differently depending on a shape of the current block. For example, if the current block is a rectangular block, a wide angle mode indicating an angle exceeding 45 degrees or less than −135 degrees in a clockwise direction can be additionally used. When the current block is a horizontal block, an angle mode can indicate an angle within an angle range (i.e., a second angle range) between (45+offset1) degrees and (−135+offset1) degrees in a clockwise direction. In this case, angle modes 67 to 76 outside the first angle range can be additionally used. In addition, if the current block is a vertical block, the angle mode can indicate an angle within an angle range (i.e., a third angle range) between (45−offset2) degrees and (−135−offset2) degrees in a clockwise direction. In this case, angle modes −10 to −1 outside the first angle range can be additionally used. According to an embodiment of the present disclosure, values of offset1 and offset2 can be determined differently depending on a ratio between the width and height of the rectangular block. In addition, offset1 and offset2 can be positive numbers.

According to a further embodiment of the present invention, a plurality of angle modes configuring the intra prediction mode set can include a basic angle mode and an extended angle mode. In this case, the extended angle mode can be determined based on the basic angle mode.

According to an embodiment, the basic angle mode is a mode corresponding to an angle used in intra prediction of the existing high efficiency video coding (HEVC) standard, and the extended angle mode can be a mode corresponding to an angle newly added in intra prediction of the next generation video codec standard. More specifically, the basic angle mode can be an angle mode corresponding to any one of the intra prediction modes {2, 4, 6, . . . , 66}, and the extended angle mode can be an angle mode corresponding to any one of the intra prediction modes {3, 5, 7, . . . , 65}. That is, the extended angle mode can be an angle mode between basic angle modes within the first angle range. Accordingly, the angle indicated by the extended angle mode can be determined on the basis of the angle indicated by the basic angle mode.

According to another embodiment, the basic angle mode can be a mode corresponding to an angle within a preset first angle range, and the extended angle mode can be a wide angle mode outside the first angle range. That is, the basic angle mode can be an angle mode corresponding to any one of the intra prediction modes {2, 3, 4, . . . , 66}, and the extended angle mode can be an angle mode corresponding to any one of the intra prediction modes {−14, −13, −12, . . . , −1} and {67, 68, . . . , 80}. The angle indicated by the extended angle mode can be determined as an angle on a side opposite to the angle indicated by the corresponding basic angle mode. Accordingly, the angle indicated by the extended angle mode can be determined on the basis of the angle indicated by the basic angle mode. Meanwhile, the number of extended angle modes is not limited thereto, and additional extended angles can be defined according to the size and/or shape of the current block. Meanwhile, the total number of intra prediction modes included in the intra prediction mode set can vary depending on the configuration of the basic angle mode and extended angle mode described above

In the embodiments described above, the spacing between the extended angle modes can be set on the basis of the spacing between the corresponding basic angle modes. For example, the spacing between the extended angle modes {3, 5, 7, . . . , 65}can be determined on the basis of the spacing between the corresponding basic angle modes {2, 4, 6, . . . , 66}. In addition, the spacing between the extended angle modes {−14, −13, . . . , −1}can be determined on the basis of the spacing between corresponding basic angle modes {53, 54, . . . , 66} on the opposite side, and the spacing between the extended angle modes {67, 68, . . . , 80}can be determined on the basis of the spacing between the corresponding basic angle modes {2, 3, 4, . . . , 15} on the opposite side. The angular spacing between the extended angle modes can be set to be the same as the angular spacing between the corresponding basic angle modes. In addition, the number of extended angle modes in the intra prediction mode set can be set to be less than or equal to the number of basic angle modes.

According to an embodiment of the present invention, the extended angle mode can be signaled based on the basic angle mode. For example, the wide angle mode (i.e., the extended angle mode) can replace at least one angle mode (i.e., the basic angle mode) within the first angle range. The basic angle mode to be replaced can be a corresponding angle mode on a side opposite to the wide angle mode. That is, the basic angle mode to be replaced is an angle mode that corresponds to an angle in an opposite direction to the angle indicated by the wide angle mode or that corresponds to an angle that differs by a preset offset index from the angle in the opposite direction. According to an embodiment of the present invention, the preset offset index is 1. The intra prediction mode index corresponding to the basic angle mode to be replaced can be remapped to the wide angle mode to signal the corresponding wide angle mode. For example, the wide angle modes {−14, −13, . . . , −1}can be signaled by the intra prediction mode indices {52, 53, . . . , 66}, respectively, and the wide angle modes {67, 68, . . . , 80}can be signaled by the intra prediction mode indices {2, 3, . . . , 15}, respectively. In this way, the intra prediction mode index for the basic angle mode signals the extended angle mode, and thus the same set of intra prediction mode indices can be used for signaling the intra prediction mode even if the configuration of the angle modes used for intra prediction of each block are different from each other. Accordingly, signaling overhead due to a change in the intra prediction mode configuration can be minimized.

Meanwhile, whether or not to use the extended angle mode can be determined on the basis of at least one of the shape and size of the current block. According to an embodiment, when the size of the current block is greater than a preset size, the extended angle mode can be used for intra prediction of the current block, otherwise, only the basic angle mode can be used for intra prediction of the current block. According to another embodiment, when the current block is a block other than a square, the extended angle mode can be used for intra prediction of the current block, and when the current block is a square block, only the basic angle mode can be used for intra prediction of the current block.

The intra-prediction unit determines reference samples and/or interpolated reference samples to be used for intra prediction of the current block, based on the intra-prediction mode information of the current block. When the intra-prediction mode index indicates a specific angular mode, a reference sample corresponding to the specific angle or an interpolated reference sample from current samples in the current block is used for prediction of a current pixel. Thus, different sets of reference samples and/or interpolated reference samples may be used for intra prediction depending on the intra-prediction mode. After the intra prediction of the current block is performed using the reference samples and the intra-prediction mode information, the decoder reconstructs sample values of the current block by adding the residual signal of the current block, which has been obtained from the inverse transform unit, to the intra-prediction value of the current block.

Motion information used for inter prediction may include reference direction indication information (inter_pred_idc), reference picture index (ref_idx_10, ref_idx_11), and motion vector (mvL0, mvL1). Reference picture list utilization information (predFlagL0, predFlagL1) may be set based on the reference direction indication information. In one example, for a unidirectional prediction using an L0 reference picture, predFlagL0=1 and predFlagL1=0 may be set. For a unidirectional prediction using an L1 reference picture, predFlagL0=0 and predFlagL1=1 may be set. For bidirectional prediction using both the L0 and L1 reference pictures, predFlagL0=1 and predFlagL1=1 may be set.

When the current block is a coding unit, the coding unit may be partitioned into multiple sub-blocks, and the sub-blocks have the same prediction information or different pieces of prediction information. In one example, when the coding unit is in an intra mode, intra-prediction modes of the sub-blocks may be the same or different from each other. Also, when the coding unit is in an inter mode, the sub-blocks may have the same motion information or different pieces of motion information. Furthermore, the sub-blocks may be encoded or decoded independently of each other. Each sub-block may be distinguished by a sub-block index (sbIdx).

The motion vector of the current block is likely to be similar to the motion vector of a neighboring block. Therefore, the motion vector of the neighboring block may be used as a motion vector predictor (MVP), and the motion vector of the current block may be derived using the motion vector of the neighboring block. Furthermore, to improve the accuracy of the motion vector, the motion vector difference (MVD) between the optimal motion vector of the current block and the motion vector predictor found by the encoder from an original video may be signaled.

The motion vector may have various resolutions, and the resolution of the motion vector may vary on a block-by-block basis. The motion vector resolution may be expressed in integer units, half-pixel units, ¼ pixel units, 1/16 pixel units, 4-integer pixel units, etc. A video, such as screen content, has a simple graphical form such as text, and does not require an interpolation filter to be applied. Thus, integer units and 4-integer pixel units may be selectively applied on a block-by-block basis. A block encoded using an affine mode, which represent rotation and scale, exhibit significant changes in form, so integer units, ¼ pixel units, and 1/16 pixel units may be applied selectively on a block-by-block basis. Information about whether to selectively apply motion vector resolution on a block-by-block basis is signaled by amvr_flag. If applied, information about a motion vector resolution to be applied to the current block is signaled by amvr_precision_idx.

In the case of blocks to which bidirectional prediction is applied, weights applied between two prediction blocks may be equal or different when applying the weighted average, and information about the weights is signaled via BCW_IDX.

In order to improve the accuracy of the motion vector predictor, a merge or AMVP (advanced motion vector prediction) method may be selectively used on a block-by-block basis. The merge method is a method that configures motion information of a current block to be the same as motion information of a neighboring block adjacent to the current block, and is advantageous in that the motion information is spatially propagated without change in a motion region with homogeneity, and thus the encoding efficiency of the motion information is increased. On the other hand, the AMVP method is a method for predicting motion information in L0 and L1 prediction directions respectively and signaling the most optimal motion information in order to represent accurate motion information. The decoder derives motion information for a current block by using the AMVP or merge method, and then uses a reference block, located in the motion information in a reference picture, as a prediction block for the current block.

A method of deriving motion information in Merge or AMVP involves a method for constructing a motion candidate list using motion vector predictors derived from neighboring blocks of the current block, and then signaling index information for the optimal motion candidate. In the case of AMVP, motion candidate lists are derived for L0 and L1, respectively, so the most optimal motion candidate indexes (mvp_10_flag, mvp_11_flag) for L0 and L1 are signaled, respectively. In the case of Merge, a single move candidate list is derived, so a single merge index (merge_idx) is signaled. There may be various motion candidate lists derived from a single coding unit, and a motion candidate index or a merge index may be signaled for each motion candidate list. In this case, a mode in which there is no information about residual blocks in blocks encoded using the merge mode may be called a MergeSkip mode.

Symmetric MVD (SMVD) is a method which makes motion vector difference (MVD) values in the L0 and L1 directions symmetrical in the case of bi-directional prediction, thereby reducing the bit rate of motion information transmitted. The MVD information in the L1 direction that is symmetrical to the L0 direction is not transmitted, and reference picture information in the L0 and L1 directions is also not transmitted, but is derived during decoding.

Overlapped block motion compensation (OBMC) is a method in which, when blocks have different pieces of motion information, prediction blocks for a current block are generated by using motion information of neighboring blocks, and the prediction blocks are then weighted averaged to generate a final prediction block for the current block. This has the effect of reducing the blocking phenomenon that occurs at the block edges in a motion-compensated video.

Generally, a merged motion candidate has low motion accuracy. To improve the accuracy of the merge motion candidate, a merge mode with MVD (MMVD) method may be used. The MMVD method is a method for correcting motion information by using one candidate selected from several motion difference value candidates. Information about a correction value of the motion information obtained by the MMVD method (e.g., an index indicating one candidate selected from among the motion difference value candidates, etc.) may be included in a bitstream and transmitted to the decoder. By including the information about the correction value of the motion information in the bitstream, a bit rate may be saved compared to including an existing motion information difference value in a bitstream.

A template matching (TM) method is a method of configuring a template through a neighboring pixel of a current block, searching for a matching area most similar to the template, and correcting motion information. Template matching (TM) is a method of performing motion prediction by a decoder without including motion information in a bitstream so as to reduce the size of an encoded bitstream. The decoder does not have an original image, and thus may schematically derive motion information of a current block by using a pre-reconstructed neighboring block.

A Decoder-side Motion Vector Refinement (DMVR) method is a method for correcting motion information through the correlation of already reconstructed reference videos in order to find more accurate motion information. The DMVR method is a method which uses the bidirectional motion information of a current block to use, within predetermined regions of two reference pictures, a point with the best matching between reference blocks in the reference pictures as a new bidirectional motion. When the DMVR method is performed, the encoder may perform DMVR on one block to correct motion information, and then partition the block into sub-blocks and perform DMVR on each sub-block to correct motion information of the sub-block again, and this may be referred to as multi-pass DMVR (MP-DMVR).

A local illumination compensation (LIC) method is a method for compensating for changes in luma between blocks, and is a method which derives a linear model by using neighboring pixels adjacent to a current block, and then compensate for luma information of the current block by using the linear model.

Existing video encoding methods perform motion compensation by considering only parallel movements in upward, downward, leftward, and rightward directions, thus reducing the encoding efficiency when encoding videos that include movements such as zooming, scaling, and rotation that are commonly encountered in real life. To express the movements such as zooming, scaling, and rotation, affine model-based motion prediction techniques using four (rotation) or six (zooming, scaling, rotation) parameter models may be applied.

Bi-directional optical flow (BDOF) is used to correct a prediction block by estimating the amount of change in pixels on an optical-flow basis from a reference block of blocks with bi-directional motion. Motion information derived by the BDOF of VVC may be used to correct the motion of a current block.

Prediction refinement with optical flow (PROF) is a technique for improving the accuracy of affine motion prediction for each sub-block so as to be similar to the accuracy of motion prediction for each pixel. Similar to BDOF, PROF is a technique that obtains a final prediction signal by calculating a correction value for each pixel with respect to pixel values in which affine motion is compensated for each sub-block based on optical-flow.

The combined inter-/intra-picture prediction (CIIP) method is a method for generating a final prediction block by performing weighted averaging of a prediction block generated by an intra-picture prediction method and a prediction block generated by an inter-picture prediction method when generating a prediction block for the current block.

The intra block copy (IBC) method is a method for finding a part, which is most similar to a current block, in an already reconstructed region within a current picture and using the reference block as a prediction block for the current block. In this case, information related to a block vector, which is the distance between the current block and the reference block, may be included in a bitstream. The decoder can parse the information related to the block vector contained in the bitstream to calculate or set the block vector for the current block.

The bi-prediction with CU-level weights (BCW) method is a method in which with respect to two motion-compensated prediction blocks from different reference pictures, weighted averaging of the two prediction blocks is performed by adaptively applying weights on a block-by-block basis without generating the prediction blocks using an average.

The multi-hypothesis prediction (MHP) method is a method for performing weighted prediction through various prediction signals by transmitting additional motion information in addition to unidirectional and bidirectional motion information during inter-picture prediction.

The cross-component linear model (CCLM) is a method that constructs a linear model by using the high correlation between a luma signal and a chroma signal at the same position as the luma signal, and then predict the chroma signal by using the linear model. A template is constructed using a block, which has been completely reconstructed, among neighboring blocks adjacent to a current block, and parameters for the linear model are derived through the template. Next, a current luma block, selectively reconstructed based on video formats so as to fit the size of a chroma block, is downsampled. Finally, the downsampled luma block and the corresponding linear model are used to predict a chroma block of the current block. In this case, a method using two or more linear models is referred to as multi-model linear mode (MMLM).

In independent scalar quantization, a reconstructed coefficient t′k for an input coefficient tk depends only on a related quantization index qk. That is, a quantization index for a random reconstructed coefficient has a different value from quantization indexes for other reconstructed coefficients. Here, t′k may be a value that includes a quantization error in tk, and may be different or the same depending on quantization parameters. Here, t′k may be called a reconstructed transform coefficient or a dequantized transform coefficient, and the quantization index may be called a quantized transform coefficient.

In uniform reconstruction quantization (URQ), reconstructed coefficients have the characteristic of being arrangement at equal intervals. The distance between two adjacent reconstructed values may be called a quantization step size. The reconstructed values may include 0, and the entire set of available reconstructed values may be uniquely defined based on the quantization step size. The quantization step size may vary depending on quantization parameters.

In the existing methods, quantization reduces the set of acceptable reconstructed transform coefficients, and elements of the set may be finite. Thus, there are limitation in minimizing the average error between an original video and a reconstructed video. Vector quantization may be used as a method for minimizing the average error.

A simple form of vector quantization used in video encoding is sign data hiding. This is a method in which the encoder does not encode a sign for one non-zero coefficient and the decoder determines the sign for the coefficient based on whether the sum of absolute values of all the coefficients is even or odd. To this end, in the encoder, at least one coefficient may be incremented or decremented by “1”, and the at least one coefficient may be selected and have a value adjusted so as to be optimal from the perspective of rate-distortion cost. In one example, a coefficient with a value close to the boundary between the quantization intervals may be selected.

Another vector quantization method is trellis-coded quantization, and, in video encoding, is used as an optimal path-searching technique to obtain optimized quantization values in dependent quantization. On a block-by-block basis, quantization candidates for all coefficients in a block are placed in a trellis graph, and the optimal trellis path between optimized quantization candidates is found by considering rate-distortion cost. Specifically, the dependent quantization applied to video encoding may be designed such that a set of acceptable reconstructed transform coefficients with respect to transform coefficients depends on the value of a transform coefficient that precedes a current transform coefficient in the reconstruction order. At this time, by selectively using multiple quantizers according to the transform coefficients, the average error between the original video and the reconstructed video is minimized, thereby increasing the encoding efficiency.

Among intra prediction encoding techniques, the matrix intra prediction (MIP) method is a matrix-based intra prediction method, and obtains a prediction signal by using a predefined matrix and offset values through pixels on the left and top of a neighboring block, unlike a prediction method having directionality from pixels of neighboring blocks adjacent to a current bloc.

To derive an intra-prediction mode for a current block, on the basis of a template which is a random reconstructed region adjacent to the current block, an intra-prediction mode for a template derived through neighboring pixels of the template may be used to reconstruct the current block. First, the decoder may generate a prediction template for the template by using neighboring pixels (references) adjacent to the template, and may use an intra-prediction mode, which has generated the most similar prediction template to an already reconstructed template, to reconstruct the current block. This method may be referred to as template intra mode derivation (TIMD).

In general, the encoder may determine a prediction mode for generating a prediction block and generate a bitstream including information about the determined prediction mode. The decoder may parse a received bitstream to set an intra-prediction mode. In this case, the bit rate of information about the prediction mode may be approximately 10% of the total bitstream size. To reduce the bit rate of information about the prediction mode, the encoder may not include information about an intra-prediction mode in the bitstream. Accordingly, the decoder may use the characteristics of neighboring blocks to derive (determine) an intra-prediction mode for reconstruction of a current block, and may use the derived intra-prediction mode to reconstruct the current block. In this case, to derive the intra-prediction mode, the decoder may apply a Sobel filter horizontally and vertically to each neighboring pixel adjacent to the current block to infer directional information, and then map the directional information to the intra-prediction mode. The method by which the decoder derives the intra-prediction mode using neighboring blocks may be described as decoder side intra mode derivation (DIMD).

FIG. 7 illustrates the position of neighboring blocks used to construct a motion candidate list in inter prediction.

The neighboring blocks may be spatially located blocks or temporally located blocks. A neighboring block that is spatially adjacent to a current block may be at least one among a left (A1) block, a left below (A0) block, an above (B1) block, an above right (B0) block, or an above left (B2) block. A neighboring block that is temporally adjacent to the current block may be a block in a collocated picture, which includes the position of a top left pixel of a bottom right (BR) block of the current block. When a neighboring block temporally adjacent to the current block is encoded using an intra mode, or when the neighboring block temporally adjacent to the current block is positioned not to be used, a block, which includes a horizontal and vertical center (Ctr) pixel position in the current block, in the collocated picture corresponding to the current picture may be used as a temporal neighboring block. Motion candidate information derived from the collocated picture may be referred to as a temporal motion vector predictor (TMVP). Only one TMVP may be derived from one block. One block may be partitioned into multiple sub-blocks, and a TMVP candidate may be derived for each sub-block. A method for deriving TMVPs on a sub-block basis may be referred to as sub-block temporal motion vector predictor (sbTMVP).

Whether methods described in the present specification are to be applied may be determined on the basis of at least one of pieces of information relating to slice type information (e.g., whether a slice is an I slice, a P slice, or a B slice), whether the current block is a tile, whether the current block is a subpicture, the size of a current block, the depth of a coding unit, whether a current block is a luma block or a chroma block, whether a frame is a reference frame or a non-reference frame, and a temporal layer corresponding a reference sequence and a layer. Pieces of information used to determine whether methods described in the present specification are to be applied may be pieces of information promised between a decoder and an encoder in advance. In addition, such pieces of information may be determined according to a profile and a level. Such pieces of information may be expressed by a variable value, and a bitstream may include information on a variable value. That is, a decoder may parse information on a variable value included in a bitstream to determine whether the above methods are applied. For example, whether the above methods are to be applied may be determined on the basis of the width length or the height length of a coding unit. If the width length or the height length is equal to or greater than 32 (e.g., 32, 64, or 128), the above methods may be applied. If the width length or the height length is smaller than 32 (e.g., 2, 4, 8, or 16), the above methods may be applied. If the width length or the height length is equal to 4 or 8, the above methods may be applied.

A residual signal may be a signal regarding the difference between an original signal and a predicted signal generated through inter prediction or intra prediction. Energy regarding the residual signal may be distributed across the entire area of the pixel domain. Therefore, there may be a problem in that, if the decoder encodes the pixel value itself of the residual signal, the compression efficiency will deteriorate. This necessitates a process of concentrating the energy of the residual signal in the pixel domain in a low-frequency area of the frequency domain by using transform coding.

The high efficiency video coding (HEVC) standard mostly uses efficient discrete cosine transform type-II (DCT-II) in signals are evenly distributed in the pixel domain (if adjacent pixel values are similar), and limitedly uses discrete sine transform type-VII (DST-DII) with regard to intra-predicted 4×4 blocks only, thereby transforming the residual signal of the pixel domain to a frequency area. The DST-DII transform may be appropriate for a residual signal generated through inter prediction (a case in which energy is evenly distributed in the pixel domain). However, a residual signal generated through intra prediction may tend to have energy increasing in proportion to the distance from reference samples, considering the characteristics of the intra prediction by which predictions are made by using reconstructed reference samples around the current encoding unit. Therefore, no high encoding efficiency can be accomplished solely by using the DST-DII transform.

The multiple transform selection (MTS) is a transform technique of adaptively selecting a transform kernel from multiple preconfigured transform kernels according to a prediction method. The pattern (signal characteristics in the horizontal direction, signal characteristics in the vertical direction) of a residual signal in the pixel domain varies depending on what prediction method is used, and a higher encoding efficiency can thus be expected than when DCT-II is simply used.

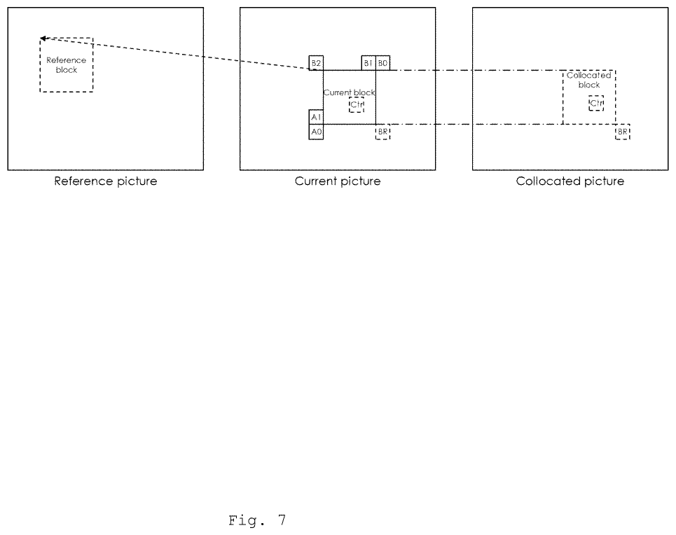

FIG. 8 illustrates the type of transform kernels according to an embodiment of the present specification.

Specifically, FIG. 8 illustrates definition of transform kernels used by MTS, and illustrates equations (basis functions) of DCT-II, DCT-V, DCT-VIII, DST-I, DST-VII, and DST-IV kernels. In the present specification, DCT-II may be described as DCT-2 (DCT2), DCT-V as DCT-5 (DCT5), DCT-VIII as DCT-8 (DCT8), DST-I as DST-1 (DST1), DST-VII as DST-7 (DST7), and DST-IV as DST-4(DST4).

DCT and DST can be expressed as a function of cosine and sine, respectively. Assuming that the basis function of a transform kernel regarding the sample number N is expressed as Tᵢ(j), index i refers to an index in the frequency domain, and index j refers to an index inside the basis function. That is, a small value of i denotes a low-frequency basis function, and a large value of i denotes a high-frequency basis function. The basis function Tᵢ(j), when expressed as a two-dimensional matrix, may denote the j^{th} element in the i^{th} row. All transform kernels illustrated in FIG. 8 have separable characteristics, and may thus perform transforms in the transverse and longitudinal directions, respectively, with regard to a residual signal X. That is, assuming that a residual signal block is X, and a transform kernel matrix is T, the transform regarding the residual signal block X may be expressed as TXT′, wherein T′ refers to the transpose of the transform kernel matrix T.

The values of transform matrices defined by the basis functions illustrated in FIG. 8 may be of a fractional number type, not an integer type. This may make it difficult to implement fractional number type values in connection with video encoding and decoding devices on a hardware basis. Therefore, a transform kernel integer-approximated from an original transform kernel including fractional number type values may be used to encode and decode video signals. An approximated transform kernel including integer type values may be generated through scaling and rounding with regard to the original transform kernel. The integer value that the approximated transform kernel includes may be a value in a range, which can be expressed by a preconfigured number of bits. The preconfigured number of bits may be 8 bits or 10 bits. The orthonormality between DCT and DST may not be maintained as a result of approximation. However, the resulting encoding efficiency loss is insignificant, and approximating the transform kernel in an integer type may thus be advantageous in terms of a hardware implementation aspect.

The identity transform (IDTR) refers to a transform which does not change input values. In general, the identity transform constructs a transform matrix having “1” in positions in which the row and column have the same value. However, in this case, the identity transform uses an arbitrary fixed value which is not “1” such that the value of an input residual signal is equally increased or decreased.

FIG. 9 illustrate the 0^{th} (the lowest frequency component of the corresponding transform kernel) basis function of DCT-II, DCT-V, DCT-VIII, DST-I, and DST-VII transforms according to an embodiment of the present specification.

Specifically, FIG. 9 is a graph regarding Ti(j) which is the transform basis function of DCT/DST defined in FIG. 8, when N is 8, and i is 0, wherein the horizontal axis denotes index j (j=0, 1, . . . , N-1) in the transform basis function, and the vertical axis denotes a signal magnitude value.

As illustrated in FIG. 9, DST-VII tends to have an increasing signal in proportion to index j, and may thus be efficient for a residual signal pattern in which, inside a residual signal block, the residual signal's energy increases in proportion to the distance in the horizontal/vertical direction with reference to the coordinate of the left upper end of the block, as in the case of intra prediction.

In contrast, DCT-VIII shows a pattern in which the signal magnitude decreases in proportion to index j, and may thus be efficient for a residual signal pattern in which, inside a residual signal block, the residual signal's energy decreases in proportion to the distance in the horizontal/vertical direction with reference to the coordinate of the left upper end of the block.

In the case of DST-I, the signal increases in proportion to index j, and the signal magnitude decreases after a specific index. Therefore, DST-I may be efficient for a residual signal pattern in which the residual signal's energy increases toward the center inside the residual block.

In the case of DCT-II, the 0^{th} basis function represent DC, and may be efficient for a residual signal pattern in which the pixel value distribution inside the residual block is uniform, as in the case of inter prediction.

DCT-V is similar to DCT-II, but has a signal model in which the value when j is 0 is smaller than the value when j is not 0, and the straight line is thus bent when j is 1.

A legacy video codec which mainly uses DCT-II only cannot perform transform adaptively to the pattern of a residual signal which varies depending on the prediction mode and the original signal's characteristics, and thus cannot accomplish an optimal encoding efficiency. However, a high compression efficiency may be expected in the case of AMT which uses various transform kernels differently according to the prediction mode, and which performs transform coding by selecting a transform kernel optimized for the pattern of a residual signal. Similarly to AMT, multiple transform selection (MTS) technology is a transform coding method in which the transform kernel is selected adaptively according to the prediction mode, thereby improving the encoding efficiency.

Hereinafter, a combination of transform kernels according to an embodiment of the present specification will be described.

DCT2 may be used as a default transform kernel for reconstructing the current block. Meanwhile, if DCT 2 is not used, the remaining kernels (for example, DCT8, DST7, DCT5, DST4, and DST1) may be used. If DCT 2 is not used, some of preconfigured combinations regarding the remaining kernels may be used. Table 1 enumerates kernel combinations excluding DCT2 and IDTR among the transform kernels illustrated in FIG. 8. That is, Table 1 enumerates combinations of five kinds of kernels DCT8, DST7, DCT5, DST4, and DST1. Specifically, Table 1 enumerates 25 combinations which can be composed by using two transform kernels as one pair (combination). A video signal processing device (for example, a decoder or an encoder) may use one of the 25 combinations in Table 1 as a transform kernel regarding the horizontal or vertical direction of the current block. Meanwhile, IDTR may be used only when a specific condition is satisfied.

```
TABLE 1 [symbol]
[25][2] =
  {
    { DCT8, DCT8 },{ DCT8, DST7 },{ DCT8, DCT5 },{ DCT8, DST4 },{DCT8, DST1},
    { DST7, DCT8 },{ DST7, DST7 },{ DST7, DCT5 },{ DST7, DST4 },{DST7, DST1},
    { DCT5, DCT8 },{ DCT5, DST7 },{ DCT5, DCT5 },{ DCT5, DST4 },{DCT5, DST1},
    { DST4, DCT8 },{ DST4, DST7 },{ DST4, DCT5 },{ DST4, DST4 },{DST4, DST1},
    { DST1, DCT8 },{ DST1, DST7 },{ DST1, DCT5 },{ DST1, DST4 },{DST1, DST1},
  };
( [symbol]   : transform kernel)
```

Table 2 enumerates combinations of three kinds of kernels DCT8, DST7, and DCT5, unlike Table 1, and Table 3 enumerates combinations of four kinds of kernels DCT8, DST7, DCT5, and DST7. The kind of kernels may be determined according to the transform kernel available for the actual transform, unlike Table 2 and Table 3. As in the case of Table 2, 9 combinations may occur if two transform kernels among three kinds of kernels constitute a pair, and as in the case of Table 3, 16 combinations may occur if two transform kernels among four kinds of kernels constitute a pair.

TABLE 2

```

[symbol]
  [9][2] =
  {
    { DCT8, DCT8 }, { DCT8, DST7 }, { DCT8, DCT5 },
    { DST7, DCT8 }, { DST7, DST7 }, { DST7, DCT5 },
    { DCT5, DCT8 }, { DCT5, DST7 }, { DCT5, DCT5 },
  };
( [symbol]   : transform kernel)
```

TABLE 3

```

[symbol]
[16][2] =
{
  { DCT8, DCT8 },{ DCT8, DST7 },{ DCT8, DCT5 },{ DCT8, DST4 },
  { DST7, DCT8 },{ DST7, DST7 },{ DST7, DCT5 },{ DST7, DST4 },
  { DCT5, DCT8 },{ DCT5, DST7 },{ DCT5, DCT5 },{ DCT5, DST4 },
  { DST4, DCT8 },{ DST4, DST7 },{ DST4, DCT5 },{ DST4, DST4 },
};
( [symbol]   : transform kernel)
```

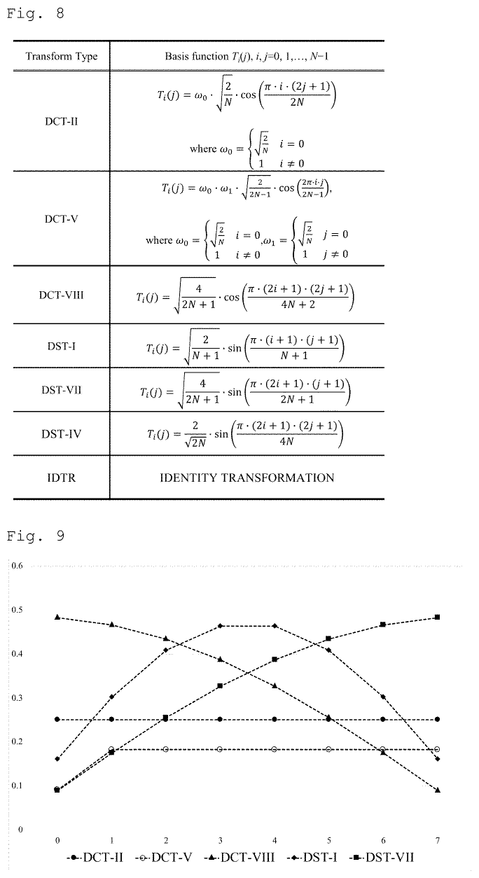

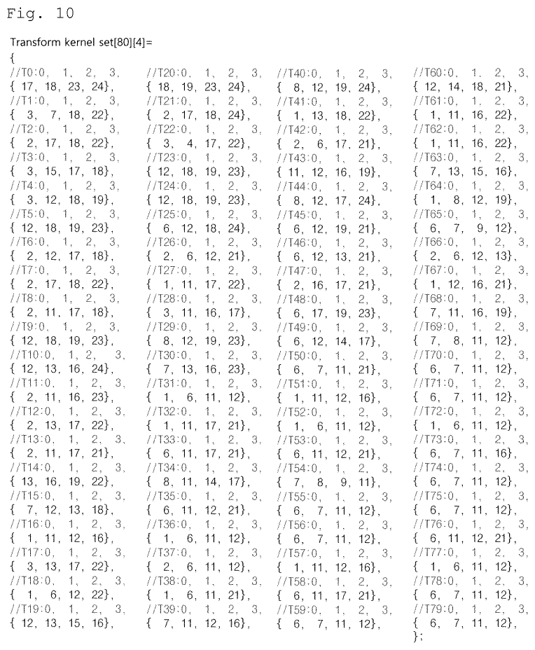

FIG. 10 and FIG. 11 illustrate transform kernel sets according to an embodiment of the present specification.

Referring to FIG. 10, transform kernel sets may be configured to include four indices. Eighty transform kernel sets may exist. Respective transform kernel sets may be given indices 0 to 79 (T0 to T79). Each of the four indices constituting a transform kernel set may denote a sub-transform kernel set. A separate index indicating each sub-transform kernel set may exist. Specifically, sub-transform kernel sets may refer to transform kernel sets configured through FIG. 10. For example, there may be a total of 25 transform kernel sets in FIG. 10, and respective transform kernels may be given indices 0 to 24. In FIG. 10, {DCT8, DCT8}, . . . , {DCT8, DST1}, {DST7, DCT8}, . . . , {DST7, DST1}, {DCT5, DCT8}, . . . , {DCT5, DST1}, {DST4, DCT8}, . . . , {DST4, DST1}, {DST1, DCT8}, . . . {DST1, DST1} may be given indices 0, . . . , 4, 5, . . . , 9, 10, . . . , 14, 15, . . . , 19, 20, . . . , 24, respectively.

For example, the transform kernel set of T20 may be used to transform the current block. The sub-transform kernel set corresponding to index 19 in the transform kernel set of T20 may be used to transform the current block. Index 19 in the transform kernel set of T20 may be indicated by a separate index (index 1). The sub-transform kernel set corresponding to index 19 may be {DST4, DST1}. The video signal processing device may reconstruct the current block on the basis of DST4 and DST1. The sub-transform kernel set may be indicated by a syntax element (mts_idx) included in a bitstream. That is, the video signal processing device may parse mts_idx so as to reconstruct the current block by using the sub-transform kernel set indicated by mts_idx.

FIG. 10 illustrates transform kernel sets configured by combining five kinds of transform kernels as in Table 1. As in Table 2 and Table 3, if the kind of transform kernels is reduced, the number of transform kernel sets needs to be adjusted accordingly. That is, if the kind of transform kernels is reduced, the number of transform kernel sets may decrease. There is an advantageous effect in that, as the number of transform kernel sets decreases, the memory capacity required for the video signal processing device decreases accordingly.

As described with reference to FIG. 10, there may be 80 predefined transform kernel sets, and each transform kernel set may include four indices indicating sub-transform kernel sets. The four indices may be grouped according to a preconfigured promise, respectively. For example, two indices may be designated as one group such that two groups are configured. Such group configuration based on a preconfigured promise may make separate information for groups unnecessary. Separate information may be necessary regarding which index in which group is indicated among respective groups. That is, the video signal processing device may signal/parse separate information included in a bitstream, thereby determining a group and determining an index in the group. For example, TO in FIG. 10 is {17, 18, 23, 24}, and 17, 18, 23, 24 of T0 may be grouped into {17, 18} and {23, 24}, respectively, according to a preconfigured promise. Other numbers of indices than two in a transform kernel set may be grouped. For example, the first group in a transform kernel set may include one index, and the second group therein may include three indices. If one index constitutes a group, no separate information for group selection may exist. A group may be determined by comparing a reference value and a value determined by the last scan position of a non-zero value among a quantization level signal regarding the current block, quantization parameter values (0-63), quantization level signal distribution (the deviation, the average value, the difference between maximum and minimum values, the number of transform coefficients, the sum of transform coefficients, the absolute value of the sum of transform coefficients), the number of non-zero transform coefficients, the standard deviation or variance value of non-zero transform coefficients, or the like (hereinafter, referred to as a grouping value). For example, the first group may be selected if the grouping value is equal to or smaller than the reference value, and the second group may be selected if the grouping value is larger than the reference value. For example, if the transform kernel set is TO, and if the grouping value is equal to or smaller than the reference value, {17, 18} may be selected, and if the grouping value is larger than the reference value, {23, 24} may be selected.

FIG. 11A illustrates a method for expanding the transform kernel sets in FIG. 10. Specifically, FIG. 10 illustrates a case in which one transform kernel set includes indices corresponding to four transform kernels, but FIG. 11A illustrates a transform kernel set including indices corresponding to six transform kernels. FIG. 11A illustrates some of 80 transform kernel sets including indices corresponding to six transform kernels. Likewise, each index constituting a transform kernel set in FIG. 11A may correspond to one of transform kernel combinations (sub-transform kernel sets) in Table 1. The transform kernel sets in FIG. 11A may be determined on the basis of the size of the current block (coding block or transformation block) and the intra prediction mode of the current block. FIG. 11B illustrates the first transform kernel set TO among the transform kernel sets in FIG. 11A. As described above, indices of a transform kernel set may be grouped into multiple groups on the basis of a preconfigured promise. That is, the number of grouped indices of a transform kernel set may be configured adaptively. The number of groups may be 3 or larger. Referring to FIG. 11B, the indices of the transform kernel set may be grouped on the basis of multiple reference values (for example, first and second reference values). For example, if the grouping value is smaller than or equal to a first reference value, a group including one index 18 may be selected; if the grouping value is larger than the first reference value and smaller than or equal to a second reference value, a group including four indices 18, 2, 17, and 23 may be selected; and if the grouping value is larger than the second reference value, a group including six indices 18, 24, 17, 23, 8, and 12 may be selected. There may be an advantageous effect in that, if the grouping value is compared with a reference value to select a corresponding group according to a pre-promised configuration, the complexity will decrease compared with a case in which one of six indices (transform kernels) is signaled/parsed with regard to the current block. The first reference value may be 6, and the second reference value may be 32.

Separate signaling may be necessary to indicate indices included in a group selected by comparing a reference value and a grouping value. For example, a group including indices 18, 24, 17, and 23 may be selected if the grouping value is larger than the first reference value and smaller than the second reference value as in FIG. 11B. Separate signaling may be necessary to indicate each of the four indices. Likewise, a group including indices 18, 24, 17, 23, 8, and 12 may be selected if the grouping value is larger than the second reference value. Separate signaling (mts_idx) may be necessary to indicate each of the six indices. Indices in a transform kernel set may be indicated by mts_idx described above, and mts_idx may have a fixed bit size. For example, mts_idx regarding six indices may have a three-bit size. Alternatively, mts_idx may be signaled by a truncated unary binarization (TB) method. As mts_idx is coded by the TB method, context model-based CABAC coding may be applied to the first bin, and TB-type CABAC coding may be applied to the remaining bins.

On the other hand, a group including index 18 may be selected if the grouping value is equal to or smaller than the first reference value. Since the group includes only one index, on separate signaling may be necessary to indicate the one index.

FIG. 12 illustrates a transform kernel set grouping method according to an embodiment of the present specification.

The above-described reference values may be fixed values which do not consider characteristics of the current block (coding block or transform block). However, referring to FIG. 12, the reference values may be changed in consideration of characteristics of the current block. The reference values may be changed on the basis of the number of samples of the current block, the quantization level value, whether a low-level tool is applied, or the like. Specifically, the reference values may be changed by increase/decrease values determined on the basis of the number of samples of the current block, the quantization level value, whether a low-level tool is applied, or the like. Referring to FIG. 12, the first reference value may be changed by the first increase/decrease value, and the second reference value may be changed by the second increase/decrease value. The first and second increase/decrease values may be identical to or different from each other. For example, assuming that increase/decrease values are determined by the quantization level value, if the quantization level value is 37, (first increase/decrease value, second increase/decrease value) may be (0, 0), and if the quantization level value is 32, (first increase/decrease value, second increase/decrease value) may be (2, 2) or (2, 3). In addition, the increase/decrease value may be calculated by “((reference quantization level value−current quantization level value)/first division value) x first multiplication value”. The reference quantization level value may be one of all quantization levels, and the first division value and the first multiplication value may be positive integers of 1 to 5.

Respective indices in a transform kernel set may be grouped on the basis of a reference value. Referring to FIG. 11 and FIG. 12, indices in a transform kernel set may be grouped into a group including one index 18, a group including four indices 18, 2, 17, and 23, and a group including six indices 18, 24, 17, 23, 8, and 12. That is, groups including 1, 4, and 6 indices, respectively, may be generated. The number of indices constituting groups may be changed adaptively. The number of indices constituting groups may be changed in consideration of characteristics of the current block. Specifically, the number of indices may be changed on the basis of the slide type in which the current block is included, the prediction mode of the current block, low-level tool information, the sum of transform coefficients, the sum of absolute values of transform coefficients, the number of non-zero transform coefficients, the standard deviation or variance value of non-zero coefficients, the quantization level value, or the like. There is an advantageous effect in that coding gain can be expected as the number of indices is changed adaptively. For example, the number of indices constituting respective groups may be configured to be 1, 3, 6, may be configured to be 1, 2, 6, may be configured to be 1, 5, 6, or may be 2, 4, 6 on the basis of the quantization level value.

The number of indices constituting respective groups may be determined (configured) by one of methods i) to iv) described below. In i) to iii), reference 1 may be 6, reference 2 may be 32, and reference A may be the number of non-zero transform coefficients (natural number).
i) number of indices=((sum of absolute values of transform coefficients>reference 2) && (number of non-zero transform coefficients>reference A))?6: ((sum of absolute values of transform coefficients>reference 1) && (number of non-zero transform coefficients>reference A))?4:1
ii) If the sum of absolute values of transform coefficients is smaller than or equal to reference 2 and larger than reference 1, and if the number of non-zero transform coefficients is larger than reference A, then the number of indices may be 4. If the sum of absolute values of transform coefficients is smaller than or equal to reference 1, and if (sum of absolute values of transform coefficients<=reference 2 && sum of absolute values of transform coefficients>reference 1 && number of non-zero transform coefficients<=reference A), then the number of indices may be 1.
iii) number of indices=((sum of absolute values of transform coefficients>reference 2))?6: ((sum of absolute values of transform coefficients>reference 1) && (number of non-zero transform coefficients>reference A))?4:1
iv) As described above, even if a group including one index according to a reference value is selected, another group may be selected if the number of non-zero transform coefficients is equal to/larger than reference B. That is, a group including four or six indices may be selected. In addition, even if a group including four indices according to a reference value is selected, a group including six indices may be selected if the number of non-zero transform coefficients is equal to/larger than reference C. Reference B and reference C may be natural numbers.

In the present specification, A?B:C refers to a function which outputs B if A is true, and outputs C if A is false.

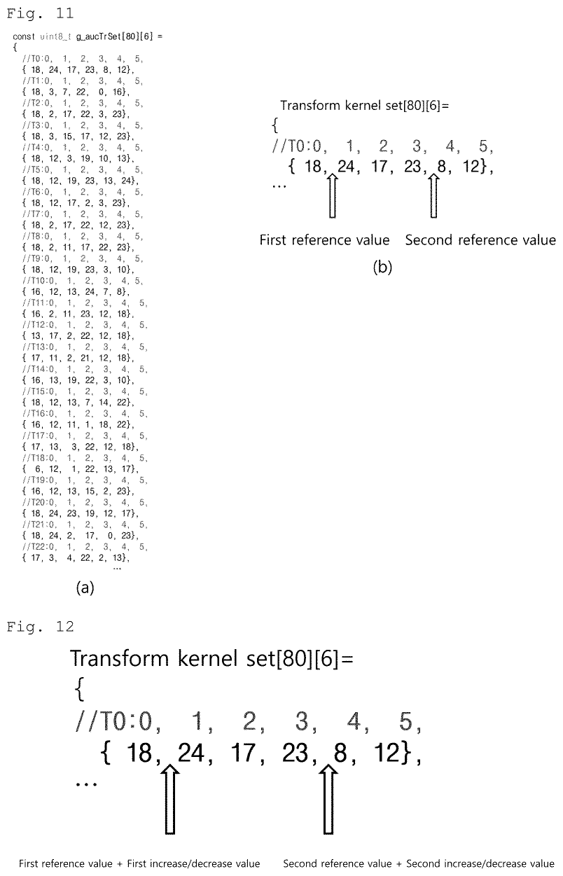

FIG. 13 illustrates remapping of indices in a transform kernel set according to an embodiment of the present specification.

If one or indices (transform kernel information) constitutes a transform kernel set, signaling information may be necessary to indicate the indices. Signaling information for indicating the transform kernel information may be indices. Hereinafter, a process of remapping indices regarding transform kernel information will be described.

Index remapping may be performed on the basis of reference values in consideration of the current block's characteristics. The reference values may be determined on the basis of the sum of absolute values of transform coefficients, the number of non-zero transform coefficients, the number of transform coefficients, the average, deviation, variance value of transform coefficients, and the like. For example, if reference values are determined on the basis of the number of non-zero transform coefficients, index remapping may be performed if the number of non-zero transform coefficients is equal to/larger than a predetermined number. Referring to FIG. 13, indices may be remapped in descending order from left to right with regard to transform kernel information. That is, the index corresponding to transform kernel information 18 may be remapped from 0 to 5, the index corresponding to transform kernel information 24 may be remapped from 1 to 4, the index corresponding to transform kernel information 17 may be remapped from 2 to 3, the index corresponding to transform kernel information 23 may be remapped from 3 to 2, the index corresponding to transform kernel information 8 may be remapped from 4 to 1, and the index corresponding to transform kernel information 12 may be remapped from 5 to 0. This is advantageous in that signaling load can be reduced by remapping indices because transform kernels corresponding to transform kernel indices positioned on the right side in the transform kernel set will be used more frequently under a predetermined condition. In addition, not the entire transform kernel information, but only a part thereof may be remapped if a specific condition is satisfied. For example, in the case of the transform kernel set in FIG. 13, transform kernel information 18 and transform kernel information 12 may be solely remapped. The transform kernel information 18 may be remapped to index 5, and transform kernel information 12 may be remapped to index 0.

Each transform kernel set in FIG. 10 may be determined on the basis of the current block's intra prediction mode and the current block's size.

FIG. 14 illustrates a transform kernel set according to an embodiment of the present specification.

A transform kernel set determined on the basis of the current block's intra prediction mode and the current block's size will be described with reference to FIG. 14.

Referring to FIG. 14, a transform kernel used in an intra prediction mode may be determined on the basis of the intra prediction model and the size of the current block (for example, coding block or transform block). The transform kernel set may include 36 indices related to the transform kernel. Each of the 36 indices may indicate one of the transform kernel sets (indices 0 to 79) in FIG. 10. A total of 16 transform kernel sets may exist, and each set may correspond to the size of the current block. In FIG. 14, reference numeral 141 denotes the type of the intra prediction mode (that is, an index indicating the intra prediction mode), and reference numeral 142 denotes the current block's size (that is, transverse size×longitudinal size). The transform kernel set based on the intra mode and the current block's size may be defined in advance. The index indicating the intra prediction mode may be 0 to 66. With reference to index 34, in order to reduce the number of transform kernel sets, an index larger than index 34 may be mapped to another index symmetric with the corresponding index. For example, index 35 may be mapped to index 33, and index 66 may be mapped to index 2.

Referring to FIG. 14, if the current block's size is 4×4, and if the index indicating the intra prediction mode is 66, the transform kernel for the current block may correspond to index 1. Likewise, if the current block's size is 32×32, and if the index indicating the intra prediction mode is 17, the transform kernel for the current block may be determined on the basis of the transform kernel set corresponding to index 77. That is, the transform kernel set corresponding to index 77 may be {1, 6, 11, 12}T77 with reference to FIG. 10. In addition, the video signal processing device may reconstruct the current block on the basis of a transform kernel included in a sub-transform kernel set corresponding to one index of T77.

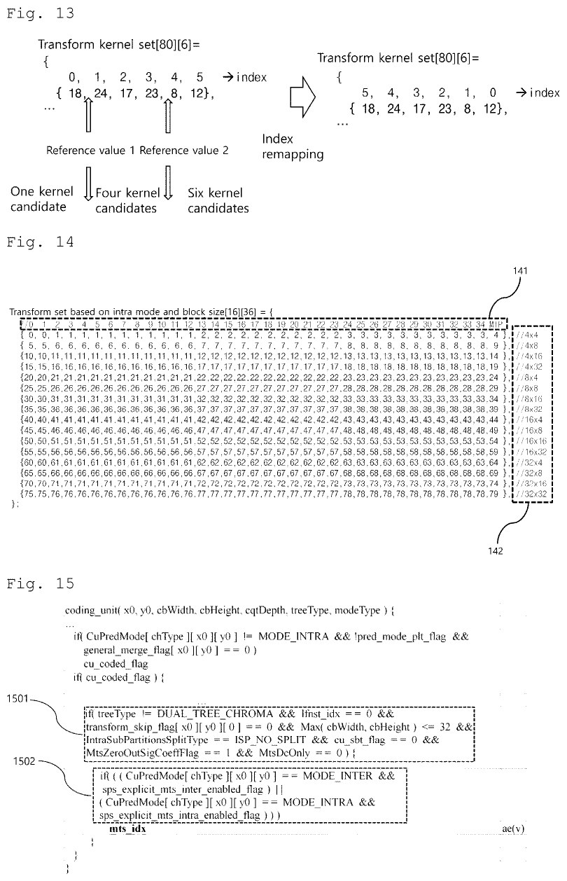

FIG. 15 illustrates a syntax structure including a kernel indicator related to MTS according to an embodiment of the present specification.

Referring to FIG. 15, the kernel indicator related to MTS may be mts_idx. Conditions 1501 and 1502 for the mts_idx to be parsed/signaled will be described with reference to FIG. 15.

First, a condition for the mts_idx to be parsed/signaled will be described with reference to 1501 in FIG. 15. i) The partitioned tree type is not to be DUAL_TREE_CHROMA. The DUAL_TREE_CHROMA may denote processing regarding the current block's chroma component when the current block is partitioned in a dual tree type. ii) The value of syntax element (lfnst_idx) related to secondary transform (LFNST) has to be equal to 0. Syntax element lfnst_idx may indicate whether secondary transform is applied to the current block. The value of lfnst_idx, if 0, may mean that no secondary transform is applied to the current block, and the value of lfnst_idx, if 1, may mean that secondary transform can be applied to the current block. iii) The value of transform skip flag (transform_skip_flag) has to be equal to 0. Syntax element transform skip flag may indicate whether transform is applied to the current block (transform block). The value of transform_skip_flag, if 1, may mean that no transform is applied to the current block (transform block), and the value of transform_skip_flag, if 0, may mean that transform can be applied to the current block (transform block). iv) The value of the larger one between transverse and longitudinal sizes of the current block has to be equal to or smaller than 32. The current block may be a coding block. v) IntraSubPartitionsSplitType has to be equal to ISP_NO_SPLIT (IntraSubPartitionsSplitType==ISP_NO_SPLIT). That is, the current block is not to be partitioned into an intra sub-partition. vi) The value of sub-block transform flag (cu_sbt_flag) has to be equal to 0. The value of cu_sbt_flag, if 1, may mean that sub-block transform is used for the current coding unit, and the value of cu_sbt_flag, if 0, may mean that no sub-block transform is used for the current coding unit. vii) The value of MtsZeroOutSigCoeffFlag has to be equal to 1. viii) The value of MtsDcOnly has to be equal to 0. Flag MtsZeroOutSigCoeffFlag may indicate whether zero out has been performed during MTS application. The value of MtsZeroOutSigCoeffFlag may be initially configured as 1 at the coding unit level, and may be changed from 1 to 0 at the residual coding level if there is a transform coefficient in an area other than the 16×16 area at the left upper end of the current block. Syntax element MtsDcOnly may indicate whether there is an effective coefficient existing in an area other than the DC area of the current block. The value of MtsDcOnly may be initially configured as 1 at the coding unit level, and may be changed to 0 if there is an effective coefficient existing in an area other than the DC area of the current block at the residual coding level.

Next, a condition for the mts_idx to be parsed/signaled will be described with reference to 1502 in FIG. 15. The condition 1502 may be additionally assessed after the condition 1501 is satisfied. i) The coding unit's prediction mode (CuPredMode) has to be an inter prediction mode (MODE INTER), and sps_explicit_mts_inter_enabled_flag has to be true (that is, 1). Syntax element sps_explicit_mts_inter_enabled_flag may indicate whether mts_idx exists in the inter coding unit syntax of a coded layer video sequence) (CLVS). The value of sps_explicit_mts_inter_enabled_flag, if 1, may mean that mts_idx may exist in the inter coding unit syntax of the CLVS, and the value of sps_explicit_mts_inter_enabled_flag, if 0, may mean that mts_idx does not exist in the inter coding unit syntax of the CLVS. iii) The coding unit's prediction mode (CuPredMode) has to be an intra prediction mode (MODE_INTRA), and sps_explicit_mts_intra_enabled_flag has to be true (that is, 1). Syntax element sps_explicit_mts_intra_enabled_flag may indicate whether mts_idx exists in the intra coding unit syntax of a coded layer video sequence) (CLVS). The value of sps_explicit_mts_intra_enabled_flag, if 1, may mean that mts_idx may exist in the intra coding unit syntax of the CLVS, and the value of sps_explicit_mts_intra_enabled_flag, if 0, may mean that mts_idx does not exist in the intra coding unit syntax of the CLVS. mts_idx may be signaled/parsed even if only one of conditions i) and ii) 1502 is satisfied.

In addition to the conditions 1501 and 1502, the following condition may be added: the value of a flag indicating whether intra template matching is applied to the current block has to be equal to 0 (that is, no application of intra template matching to the current block is indicated), and the value of a flag indicating whether template-based Intra mode derivation (TIMD) is applied has to be equal to 0 ((!TIMD, no application of TIMD is indicated).

Hereinafter, a transform kernel indicating method according to an embodiment of the present specification will be described.

A transform kernel may be applied in the vertical direction and/or horizontal direction in order to reconstruct a transform block. Depending on a combination of transform kernels, the same transform kernel or different transform kernels may be used in the vertical and horizontal directions. For example, one of the transform kernel sets in FIG. 10 may be determined on the basis of the current block's size and the intra prediction mode, and one sub-transform kernel set (refer to FIG. 10) in a transform kernel set determined by mts_idx may be indicated. Moreover, it may be determined which transform kernel in the sub-transform kernel set is to be used on the basis of the index of the intra prediction mode. For example, as a method for determining a transform kernel used in the vertical direction, if the index of the intra prediction mode is larger than 34 (DIA_IDX), the second transform kernel in the sub-transform kernel set may be used. If the index of the intra prediction mode is smaller than 34 (DIA_IDX), the first transform kernel in the sub-transform kernel set may be used. As a method for determining a transform kernel used in the horizontal direction, if the index of the intra prediction mode is larger than 34 (DIA_IDX), the first transform kernel in the sub-transform kernel set may be used. If the index of the intra prediction mode is smaller than 34 (DIA_IDX), the second transform kernel in the sub-transform kernel set may be used. That is, as in Table 4, a transform kernel in the sub-transform kernel set may be determined according to the index determined by comparing the index (predMode) of the intra prediction mode and the size of DIA_IDX. Specifically, if the determined index is 0, the first transform kernel in the sub-transform kernel set may be used, and if the determined index is 1, the second transform kernel in the sub-transform kernel set may be used.

[Table 4] Vertical direction transform kernel=preMode>DIA_IDX?1:0 Horizontal direction transform kernel=preMode>DIA_IDX?0:1

Hereinafter, a method for determining whether IDTR is applied to the current block (transform block) will be described. First, the value of mts_idx has to be equal to 3, and the width and height of the transform block both have to be equal to or smaller than 16. In addition, if the absolute value of the difference between the index of the intra prediction mode of the current block and the index (HOR_IDX=18) of the intra prediction mode in the vertical direction is equal to or smaller than the IDT transform reference value, the transform kernel applied in the vertical direction of the current block may be IDTR. Furthermore, if the absolute value of the difference between the index of the intra prediction mode of the current block and the index (VER_IDX=50) in the horizontal direction is equal to or smaller than the IDT transform reference value, the transform kernel applied in the horizontal direction of the current block may be IDTR. The IDT transform reference value may be calculated as [floorLog2 (width)−2][floorLog2(height)−2]. Function floor(x) returns the largest integer among integers smaller than x. width may refer to the current block's width, and height may refer to the current block's height. That is, the method for determining whether IDTR is applied is as in Table 5 below:

```
TABLE 5
if (mts_idx == 3 && width <= 16 && height <= 16)
  {
    if (abs(predMode − HOR_IDX) <= IDT [symbol]   [floorLog2(width) − 2][floorLog2(height) − 2])
    {
      trTypeVer = IDTR;
    }
    if (abs(predMode − VER_IDX) <= IDT [symbol]   [floorLog2(width) − 2][floorLog2(height) − 2])
    {
      trTypellor = IDTR;
    }
  }
      (IDT [symbol]   : IDT transform reference value)
```

In addition, the IDT transform reference value may be 8, 6, 4, 8, 8, 6, 4, 2, or −1. Respective reference values may correspond to cases in which the block size is 4×4, 4×8, 4×16, 8×4, 8×8, 8×16, 16×4, 16×8, and 16×16, respectively.

FIG. 16 illustrates a method in which an inverse transform unit of a video signal processing device transforms the current block without separate signaling.

A video signal processing device may perform inverse transform through entropy decoding and inverse quantization. If there is no transform kernel specified, information (for example, syntax element) indicating which transform kernel has been used may be signaled/parsed. Referring to FIG. 13, multiple transform kernels may be used if an adaptive multi-transform kernel is used. For example, if transform kernel set TO in FIG. 10 is selected, a transform kernel in the sub-transform kernel set corresponding to the index that constitutes TO may be used. Hereinafter, a method for determining a transform kernel which is used without a separate indicator will be described.

i) The transform kernel set may be determined on the basis of the current block's inter prediction mode and the current block's size. ii) The vertical/horizontal transform kernel is determined on the basis of the current predicted block as described with reference to FIG. 14. iii) The video signal processing device generates respective transform kernel-specific residual signals corresponding to respective indices of a sub-transform kernel set in the transform kernel set. iv) In addition, the video signal processing device generates an intra prediction signal and then combines the intra prediction signal and each kernel-specific residual signal, thereby generating each reconstructed signal (predicted sample). v) The video signal processing device calculates the cost on the basis of each generated reconstructed signal. vi) In addition, a reconstructed signal may be generated by using a transform kernel corresponding to the minimum cost. That is, the transform kernel corresponding to the minimum cost may be used to reconstruct the current block. In v), the video signal processing device may realign transform kernels on the basis of the calculated cost. The video signal processing device may signal/parse information regarding the index regarding an appropriate transform kernel among the realigned transform kernels. For example, the encoder may generate a bitstream including information regarding the index regarding a transform kernel most appropriate for reconstruction of the current block among the realigned transform kernels, and the decoder may parse the corresponding index, thereby acquiring the index regarding the most appropriate transform kernel, and may reconstruct the current block on the basis of the transform kernel corresponding to the acquired index.

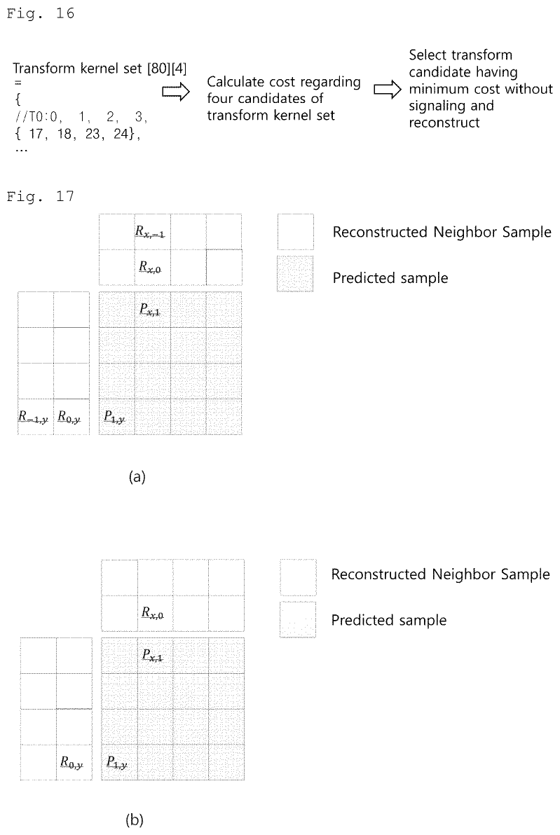

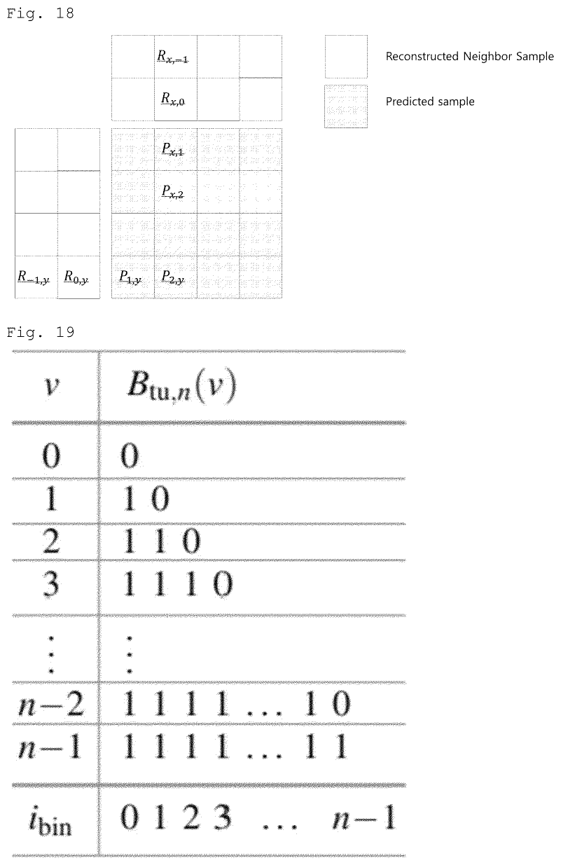

FIG. 17 and FIG. 18 illustrate a cost calculation method according to an embodiment of the present specification.

The cost calculation method described with reference to FIG. 16 will now be described with reference to FIG. 17 and FIG. 18.

The cost may be calculated by comparing a neighbor block (sample) of the current block, which has already been reconstructed, and a reconstructed signal (predicted sample) generated by combining each transform kernel-specific residual signal.

Referring to FIG. 17A, the video signal processing device may calculate the cost on the basis of two already-reconstructed neighbor blocks (samples) and one current predicted sample. Specifically, the cost may be calculated on the basis of Equation 1. Referring to FIG. 17B, the video signal processing device may calculate the cost on the basis of one already-reconstructed neighbor block (sample) and one current predicted sample. Specifically, the cost may be calculated on the basis of Equation 2. Referring to FIG. 18, the video signal processing device may calculate the cost on the basis of two already-reconstructed neighbor blocks (samples) and two current predicted samples. Specifically, the cost may be calculated on the basis of Equation 3.

In Equations 1, 2, and 3, R may refer to the value of an already-reconstructed neighbor block (sample), P may refer to the value of the current predicted sample, w may refer to the width of the current block, and h may refer to the height of the current block. In addition, subscripts of R and P may be information (for example, coordinate values) indicating the sample's position.

$$[ Equation 1 ]$$

$$cost = {\sum }_{x = o}^{w} \vert ( - {R}_{x - 1} + 2 {R}_{x , 0} - {P}_{x , 1} ) \vert + {\sum }_{y = o}^{h} \vert ( - {R}_{- 1 y} + 2 {R}_{0 , y} - {P}_{1 , y} ) \vert$$

$$cost = {\sum }_{x = o}^{w} \vert ( {R}_{x , 0} - {P}_{x , 1} ) \vert + {\sum }_{y = o}^{h} \vert ( {R}_{0 , y} - {P}_{1 y} ) \vert \qquad [ Equation 2 ]$$

$$[ Equation 3 ]$$

$$cost = {\sum }_{x = o}^{w} ( \vert 2 {P}_{x , 1} - {P}_{x , 2} - {R}_{x , 0} \vert + \vert 2 {R}_{x , 0} - {P}_{x , 1} - {R}_{x , - 1} \vert ) + {\sum }_{y = o}^{h} ( \vert 2 {P}_{1 , y} - {P}_{2 , y} - {R}_{0 , y} \vert + \vert 2 {R}_{0 , y} - {P}_{1 y} - {R}_{- 1 , y} \vert )$$

The method of selecting a transform kernel on the basis of the cost may also be applied to a case in which indices in the transform kernel set are grouped into multiple groups on the basis of a reference value. The cost may be calculated only with regard to transform kernels corresponding to indices included in one of the multiple groups. In addition, the video signal processing device may reconstruct the current block by using a transform kernel having the minimum cost among calculated costs.

FIG. 19 illustrates the structure of truncated unary binarization according to an embodiment of the present specification.

Referring to FIG. 19, the truncated unary binarization may have a structure in which the required amount of information (for example, bit size) increases in proportion to the value of index v. If relatively low indices have high frequencies of occurrence, the video signal processing device can conduct signaling with a small amount of information, which is effective in terms of memory use.

FIG. 20 illustrates context coding and context modeling according to an embodiment of the present specification.

Syntex element mts_idx may indicate the index of a sub-transform kernel set in a transform kernel set. For example, mts_idx may indicate one of indices of four sub-transform kernel sets in a transform kernel set, and may indicate one of indices of six sub-transform kernel sets in a transform kernel set. FIG. 20A illustrates TB information with regard to respective indices of six sub-transform kernel sets using the TB method in FIG. 19. Referring to FIG. 20A, one bin may be added each time the index increases by 1, and the TB information regarding the last index (5) may be filled with 1 without bin addition. For example, if the sub-transform kernel set has four indices unlike FIG. 20A, indices 0 to 2 may have the same TB information as FIG. 20A, but the TB information of index 3 may be 111. That is, a total of three bins may be necessary if the sub-transform kernel set has four indices. Context coding may be applied to the first bin of mts_idx according to an embodiment of the present specification. Upon applying context coding to the first bin, the total number of indices of the TB information may be reduced by one. A context model necessary for context coding will now be described.

The context model may be configured according to how many indices are used (that is, the number of sub-transform kernel sets). For example, initValue and shiftIdx may have identical or different values depending on whether four indices are used or six indices are used. initValue may denote the initial context model value, and shiftIdx may denote the context model's probability update value.

Referring to FIG. 20B, the context model may be configured on the basis of whether MTS is applied to neighbor blocks of a block in a preconfigured position of the current block. For example, the neighbor blocks of a block in a preconfigured position may include a left neighbor block and an upper neighbor block. If the preconfigured position is (0, 0), the position of the left neighbor block may be (−1, 0), and the position of the upper neighbor block may be (0, −1). Three context models may be used by configuring 0 if MTS is not applied to any neighbor block, 1 if MTS is applied to at least one neighbor block, and 2 if MTS is applied to all neighbor blocks. The value of initValue and shiftIdx may be configured with regard to each context model.

In addition, the value of initValue and shiftIdx of each context model may be determined according to the slice type (for example, I slice, B slice, P slice).

Methods described in the present specification may also be applied to signaling/parsing of a syntax element (lfnst_idx) related to secondary transform. Instead of fixed kernel candidates regarding secondary transform and fixed signaling bits, the number of kernel candidates regarding secondary transform can be used adaptively through lfnst_idx, and the bit size can also be changed adaptively. There may be four or six kernel candidates regarding secondary transform. Signaling of lfnst_idx may be configured on the basis of the sum of absolute values of transform coefficients in the region of interest (ROI) filled with coefficients regarding secondary transform, the number of non-zero transform coefficients, the average of transform coefficients, the position of the last transform coefficient, the deviation of transform coefficients, the variance thereof, or the like.

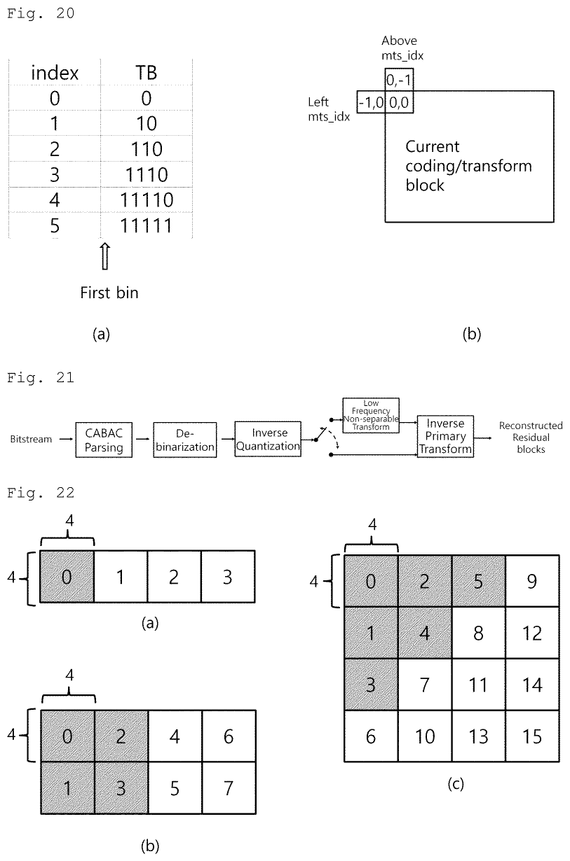

FIG. 21 illustrates a residual signal reconstruction process according to an embodiment of the present specification.

The residual signal, which corresponds to the difference between the original signal and a predicted signal, tends to have a signal energy distribution varying depending on the prediction method. Therefore, the encoding efficiency may be improved by adaptively selecting a transform kernel according to the prediction method as in the case of MTS. In addition, assuming that the transform that uses an MTS or DCT2 kernel only is primary transform, the video signal processing device may improve the encoding efficiency by additionally performing secondary transform with regard to the primarily transformed coefficient block. The secondary transform is particularly advantageous in terms of energy compaction with regard to an intra-predicted residual signal block which has a high degree of possibility that strong energy will exist in a direction other than the horizontal or vertical direction of the residual signal block.

Referring to FIG. 21, the video signal processing device may parse a syntax element related to a residual signal included in a bitstream, and may reconstruct a quantization coefficient through de-binarization based on the parsing result. The video signal processing device may acquire a transform coefficient by inversely quantizing the reconstructed quantization coefficient. The video signal processing device may reconstruct a residual signal block by inversely transforming the transform coefficient. The inverse transform may be applied to a block to which transform skip (TS) is not applied. The video signal processing device may perform inverse transform in the order of secondary inverse transform and primary inverse transform. The secondary inverse transform may be skipped. For example, the secondary inverse transform may be skipped if the current block has been encoded in the inter prediction mode. In addition, the secondary inverse transform may be skipped according to the current block's size. The reconstructed residual signal includes quantization errors, and the secondary transform may change the energy distribution of the residual signal, thereby reducing quantization errors compared with the case in which primary transform is solely performed.

FIG. 22 illustrates the ROI of blocks to which secondary transform is applied according to an embodiment of the present specification.

The numbers assigned to sub-blocks in FIG. 22 according to an embodiment of the present specification may be sub-block indices, and sub-blocks may be scanned in ascending order of the sub-block indices.

FIG. 22A illustrates the ROI of LFNST4. The ROI of LFNST4 may be related to a transform block having a 4×N or N×4 size. N may be an integer of 4-128. Referring to FIG. 22A, the ROI of LFNST4 may be the ROI of a 16×4 block including four sub-blocks (sub-blocks 0 to 3). The ROI is one sub-block having a 4×4 size, and referring to FIG. 22A, the ROI corresponds to sub-block 0. The number of input samples of the ROI may be 16. The forward transform matrix of LFNST4 may be R×16, wherein R may be 4, 8, 16, or the like. For example, if R is 16, 16 transform coefficients may be generated as a result of transform. Hereinafter, the ROI of LFNST4 will be described more comprehensively.
i) (Line-based ROI configuration method) For example, if the transform block has a 4×N size, the ROI of LFNST4 may correspond to an area having a 4×M size, including the left upper end of the transform block to which a transform coefficient is allocated. M may be an integer of 1 or larger. If M is 3, the ROI of LFNST4 may correspond to an area having a 4×3 size, and the video signal processing device may encode 12 transform coefficients. Information regarding M may be included in a bitstream. That is, the decoder may identify M by parsing the information regarding M included in the bitstream. When the information regarding M is parsed, a CABAC context model configured on the basis of at least one of a quantization parameter, the current transform block's size, and the current transform block's neighbor block's transform coefficient may be used.
ii) (Sample-based ROI configuration method) For example, if the transform block has a 4×N size, the ROI of LFNST4 may correspond to an area to which a specific number of transform coefficients is allocated according to a specific scan order with reference to the left upper end of the transform block. The specific scan order may be horizontal, vertical, diagonal, inversely diagonal, inversely horizontal, inversely vertical, and/or a pre-promised scan order, and the specific number may be an integer of 1 or larger. If there are ten transform coefficients, ten transform coefficients may be allocated in the horizontal direction with reference to the left upper end of the transform block having a 4×N size, and the area in which transform coefficients are allocated may be the ROI. In addition, transform coefficients may be allocated on the basis of the sub-block size. For example, if the sub-block has a 4×4 size, and if ten transform coefficients are allocated in the horizontal direction, four transform coefficients may be allocated to the first row of the sub-block, including the upper end of the transform block having a 4×N size, next four transform coefficients may be allocated to the second row of the sub-block, and two transform coefficients may be allocated to the third row of the sub-block. Information regarding the scan order and the number of transform coefficients may be included in a bitstream. That is, the decoder may configure the ROI regarding the current transform block by parsing information regarding the scan order and information regarding the transform coefficients. When parsing information regarding the scan order and information regarding the transform coefficients, a CABAC context model configured on the basis of at least one of a quantization parameter, the current transform block's size, and the current transform block's neighbor block's transform coefficient may be used. In addition, no information regarding the scan order may be included in the bitstream. The scan order may then be determined on the basis of at least one of the current block's size, the intra prediction mode, the current block's color component (whether a luminance component or a chrominance component), and information regarding the primary transform type.

The above-described line-based ROI configuration method and sample-based ROI configuration method may be similarly applied to the ROI of LFNST8 and ROI of LFNST16 described below.

FIG. 22B illustrates the ROI of LFNST8. The ROI of LFNST8 may be the ROI regarding a transform block having a 8×N or N×8 size. N may be an integer of 8-128. Referring to FIG. 22B, the ROI of LFNST8 may be the ROI in a 16×8 block including eight sub-blocks (sub-blocks 0 to 7). The ROI may be an area corresponding to four sub-blocks having a 4×4 size, and referring to FIG. 22B, the ROI corresponds to sub-blocks 0, 1, 2, and 3. The number of input samples of the ROI may be 64. The forward transform matrix of LFNST8 may be R×64, wherein R may be 8, 16, 32, 64, or the like. For example, if R is 32, 32 transform coefficients may be generated as a result of transform.

FIG. 22C illustrates the ROI of LFNST16. The ROI of LFNST16 may be the ROI regarding a transform block having a 16×N or N×16 size. N may be an integer of 16-128. Referring to FIG. 22C, the ROI of LFNST16 may be the ROI in a 16×16 block including 16 sub-blocks (sub-blocks 0 to 15). The ROI may be an area corresponding to six sub-blocks having a 4×4 size, and referring to FIG. 22C, the ROI corresponds to sub-blocks 0, 1, 2, 3, 4, and 5. The number of input samples of the ROI may be 96. The forward transform matrix of LFNST8 may be R×96, wherein R may be 8, 16, 32, 64, 96, or the like. For example, if R is 32, 32 transform coefficients may be generated as a result of transform.

FIG. 23 illustrates a method for applying secondary transform (LFNST) according to an embodiment of the present specification.

The secondary transform may be expressed as the product of a secondary transform kernel's matrix and a primarily transformed coefficient vector. That is, primarily transformed coefficients are interpreted as being mapped to another space. There is an advantageous effect in that, if the number of secondarily transformed coefficients is reduced, that is, if the number of basis vectors constituting the secondary transform kernel is reduced, the amount of computation necessary for the secondary transform and the memory capacity necessary to store the transform kernel can be reduced. For example, when the video signal processing device performs secondary transform with regard to the area corresponding to the ROI at the left upper end of the transform block, and if the number of secondarily transformed coefficients is reduced to 32, a secondary transform kernel having a 32×96 size may be applied, and an inverse secondary transform kernel having a 96×32 size may be applied.

Referring to FIG. 23, the encoder may perform forward primary transform with regard to a residual signal block, thereby obtaining a primarily transformed coefficient block. The residual signal may be acquired by intra prediction. The primarily transformed coefficient block may have a M×N size. The encoder may perform forward primary transform with regard to a residual signal block, the value of min(M,N) of which is 16, thereby obtaining a primarily transformed coefficient block. In addition, the encoder may perform 32×96 secondary transform (LFNST) with regard to the samples (sub-blocks 0 to 5 in FIG. 23) in the ROI area at the left upper end of the primarily transformed coefficient block. The encoder may also perform forward primary transform with regard to a residual signal block, the value of min(M,N) of which is 8, thereby obtaining a primarily transformed coefficient block. In addition, the encoder may perform secondary transform with regard to the samples in the ROI area at the left upper end of the primarily transformed coefficient block.

Referring to FIG. 23, transform coefficients of the entire transform block size including secondarily transformed coefficients may be quantized, and information regarding the quantized transform coefficients may be included in the bitstream. In addition, the bitstream may include a syntax element (lfnst_idx) related to secondary transform. Specifically, the bitstream may include information indicating whether secondary transform is applied to the current block and indicating the transform kernel.

Referring to FIG. 23, the decoder may parse quantized transform coefficients from the bitstream and may acquire transform coefficients through de-quantization. The decoder may determine whether or not to perform inverse secondary transform (inverse LFNST) with regard to the current transform block on the basis of the syntax element related to secondary transform. When inverse secondary transform is applied to the current transform block, 16 or 32 transform coefficients may be the input to the inverse secondary transform, depending on the transform block's size. The number of transform coefficients that are the input to the inverse secondary transform may be identical to the number of transform coefficients acquired by the encoder through secondary transform. The decoder may acquire primarily transformed coefficients by multiplying vectorized transform coefficients and an inverse secondary transform kernel matrix. The inverse secondary transform kernel may be determined on the basis of the transform block's size, the intra prediction model, and the syntax element indicating the transform kernel. The inverse secondary transform kernel matrix may be the transpose of the secondary transform kernel matrix, and elements of the kernel matrix may be integers expressed at the level of 10-bit or 8-bit accuracy in consideration of the complexity of implementation. Primary transform coefficients acquired through inverse secondary transform are of a vector type, and may thus expressed as two-dimensional data. The primary transform coefficients may depend on the intra prediction mode. The mapping relation based on the intra prediction mode applied in the encoder may be equally applied. The decoder may acquire a residual signal by performing inverse primary transform with regard to the transform coefficient block of the entire transform block size, including transform coefficients acquired by performing inverse secondary transform.

The series of processes described with reference to FIG. 23 may include a scaling process which uses a bit shift operation.

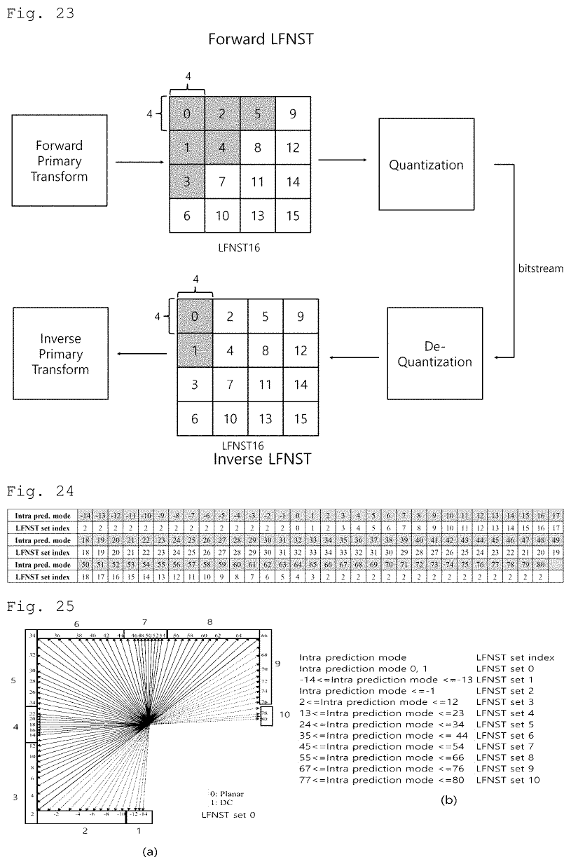

FIG. 24 and FIG. 25 illustrate a mapping relation between intra prediction modes and transform kernel sets for secondary transform according to an embodiment of the present specification.

A transform kernel set for LFNST applied to a transform block may be determined with regard to each intra prediction mode of the transform block. One transform kernel set may include multiple LFNST kernels. For example, one transform kernel set may include three or four LFNST kernels. There may be 35 transform kernel sets, and respective transform kernel sets may be given indices 0 to 34. Intra prediction mode indices −14 to −1 and 67 to 80, which correspond to an expanded angle mode, may be mapped to the transform kernel set of index 2.

FIG. 25 illustrates a method for sub-grouping the mapping relation between intra prediction modes and transform kernel sets illustrated in FIG. 24. Referring to FIG. 25A, intra prediction modes may be grouped. That is, intra prediction mode indices 0 and 1 may be grouped into one sub-group (sub-group 0), intra prediction mode indices −11 to −14 may be grouped into one sub-group (sub-group 1), intra prediction mode indices −1 to −10 may be grouped into one sub-group (sub-group 2), intra prediction mode indices 2 to 12 may be grouped into one sub-group (sub-group 3), intra prediction mode indices 13 to 23 may be grouped into one sub-group (sub-group 4), intra prediction mode indices 24 to 34 may be grouped into one sub-group (sub-group 5), intra prediction mode indices 35 to 44 may be grouped into one sub-group (sub-group 6), intra prediction mode indices 45 to 54 may be grouped into one sub-group (sub-group 7), intra prediction mode indices 55 to 66 may be grouped into one sub-group (sub-group 8), intra prediction mode indices 67 to 76 may be grouped into one sub-group (sub-group 9), and intra prediction mode indices 77 to 80 may be grouped into one sub-group (sub-group 10). In addition, each sub-group may be mapped to a transform kernel set. Referring to FIG. 25B, sub-group 0 may be mapped to transform kernel set 0, sub-group 1 may be mapped to transform kernel set 1, sub-group 2 may be mapped to transform kernel set 2, and remaining sub-groups may be mapped to respective transform kernel sets in the same manner. Alternatively, multiple sub-groups may be mapped to one transform kernel set. That is, sub-groups may be regrouped, and a transform kernel set may be mapped to the regrouped sub-groups. For example, sub-groups 1 and 7 may be mapped to the same transform kernel set, sub-groups 2 and 6 may be mapped to the same transform kernel set, sub-groups 3 and 5 may be mapped to the same transform kernel set, sub-groups 4 and 10 may be mapped to the same transform kernel set, sub-groups 6 and 8 may be mapped to the same transform kernel set, and sub-groups 5 and 9 may be mapped to the same transform kernel set.

It may be inefficient to map intra prediction modes corresponding to an expanded angle mode to one transform kernel set (transform kernel set of index 2). It may be inefficient to map various expanded angle modes to one transform kernel set in connection with secondary transform. Negative-numbered code expanded angle modes (indices −2 to −14) may be mapped to a transform kernel set used by a corresponding positive-numbered intra prediction mode, assuming that the intra prediction mode of index 2 is a symmetric axis. Alternatively, the intra prediction mode of index 18 may be used as a symmetric axis, and the center point in FIG. 25A may be used as a symmetric axis. Positive-numbered code expanded angle modes (indices 67 to 80) may be mapped to a transform kernel set used by a corresponding positive-numbered intra prediction mode, assuming that the intra prediction mode of index 66 is a symmetric axis. Alternatively, the intra prediction mode of index 50 may be used as a symmetric axis, and the center point in FIG. 25A may be used as a symmetric axis. For example, if the intra prediction mode of index −2 is made symmetric by using the intra prediction mode of index 2 as a symmetric axis, the same becomes the intra prediction mode of index 4. That is, the intra prediction mode of index −2 may be mapped to the transform kernel set mapped to the intra prediction mode of index 4. In addition, if the intra prediction mode of index −2 is made symmetric by using the intra prediction mode of index 18 as a symmetric axis, the same becomes the intra prediction mode of index 36. That is, the intra prediction mode of index −2 may be mapped to the transform kernel set mapped to the intra prediction mode of index 36. In addition, if the intra prediction mode of index −2 is made symmetric by using the center point in FIG. 25A, the same becomes the intra prediction mode of index 64. That is, the intra prediction mode of index −2 may be mapped to the transform kernel set mapped to the intra prediction mode of index 64.

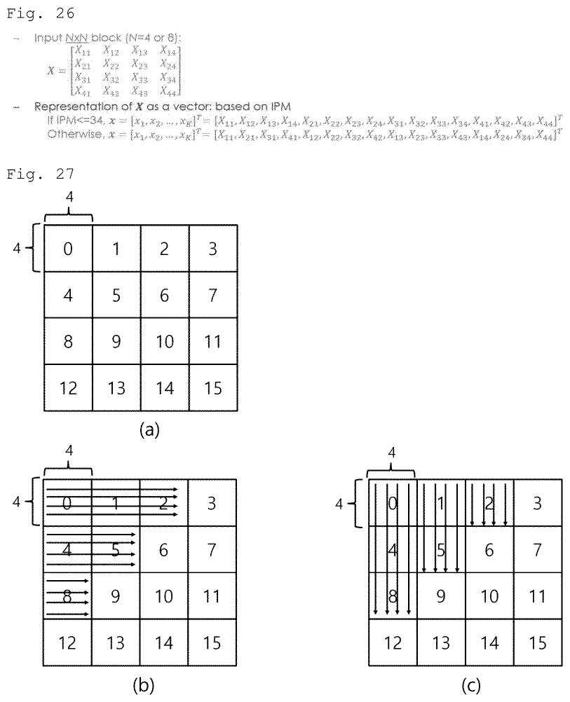

FIG. 26 illustrates a relation between a secondary transform's input vector and an intra prediction mode.

The secondary transform may be calculated as the product of a secondary transform kernel matrix and an input vector. The video signal processing device may configure coefficients in the sub-block at the left upper end of a primarily transformed coefficient block in a vector type. The vector may be configured so as to depend on the intra prediction mode. For example, if the intra prediction mode is a prediction mode corresponding to an index equal to or smaller than index 34 in FIG. 6, or is an INTRA_LT_CCLM, INTRA_T_CCLM, INTRA_L_CCLM mode which predicts a chroma sample by using the chroma's linear relation, the video signal processing device may configure coefficients in a vector type by scanning the sub-block at the left upper end of a primarily transformed coefficient block in the transverse direction. An element in the i^{th} row and j^{th} column of the n×n block at the left upper end of the primarily transform coefficient block may be described as x_ij. The vectorized coefficients may be expressed as [x_00, x_01, . . . , x_0n-1, x_10, x_11, . . . , x_1n-1, . . . , x_n-10, x_n-11, . . . , x_n-1n-1]. On the other hand, if the intra prediction mode corresponds to an index larger than index 34 in FIG. 6, the video signal processing device may configure coefficients in a vector type by scanning the sub-block at the left upper end of a primarily transformed coefficient block in the longitudinal direction. The vectorized coefficients may be expressed as [x_00, x_10, . . . , xn-10, x_01, x_11, . . . , xn-11, x_0n-1, x_1n-1, . . . , x_n-1n-1].

The secondary transformed coefficients are of a vector type and thus can be expressed two-dimensional data. The secondary transformed coefficients may be allocated to the sub-block at the left upper end of the transform block according to a preconfigured scan order. The preconfigured scan order may be an up-right diagonal scan order.

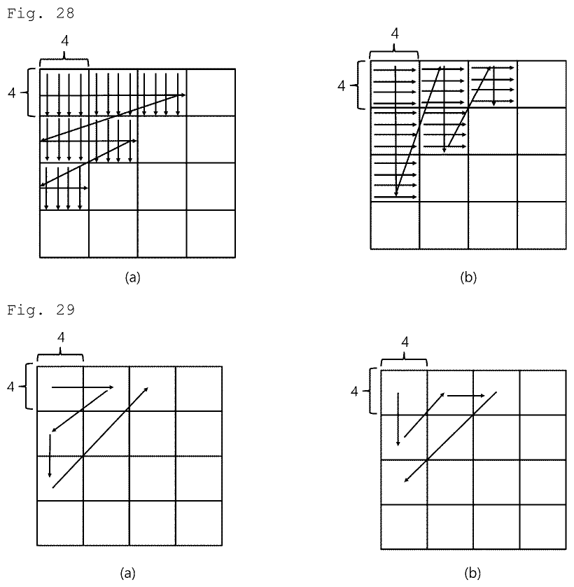

FIG. 27 to FIG. 30 illustrate a method for constructing an input vector of secondary transform according to an embodiment of the present specification.

FIG. 27 to FIG. 29 illustrate a method for using forward primary transform coefficients as an input vector of LFNST. Although no sub-block index is illustrated in FIG. 28 and FIG. 29, the sub-block may be indexed in the same manner as in FIG. 27. Referring to FIG. 27 to FIG. 29, the ROI of LFNST16 may correspond to six 4×4 sub-blocks. A total of 96 primary transform coefficients may be used, and the matrix of the transform kernel of LFNST16 may be 32×96. A total of 96 transform coefficients may be configured as a 96×1 input vector.

Referring to FIG. 27A, the current block may include sixteen 4×4-sized sub-blocks, and respective sub-blocks may be mapped to indices 0 to 15. The ROI of LFNST16 may be an area corresponding to sub-blocks corresponding to indices 0, 4, 8, 1, 5, and 2.

Referring to FIG. 27B, a horizontal (transverse) scan order may be used to configure an input vector. That is, the video signal processing device may scan transform coefficients in the order of sub-blocks corresponding to indices 0, 1, 2, 4, 5, and 8. In other words, 12 samples in the first row may be successively scanned in the transverse direction of consecutive sub-blocks of indices 0, 1, and 2; 12 samples in the second row may then be scanned; 12 samples in the third row may then be scanned; and 12 samples in the fourth row may then be scanned. In addition, four samples in each of the fifth to eighth rows may be scanned in the transverse direction of consecutive sub-blocks of indices 4 and 5. In addition, four samples in each of the ninth to twelfth rows may be scanned in the transverse direction of sub-blocks of index 8. If the current block's encoding mode is an intra prediction mode corresponding to an index larger than the intra prediction mode of index 34, an input vector may be configured in a scan order in the vertical (longitudinal) direction as in FIG. 27C. That is, the video signal processing device may scan transform coefficients in the order of sub-blocks corresponding to indices 0, 4, 8, 1, 5, and 2, thereby configuring an input vector.

Referring to FIG. 28A, the video signal processing device may scan in the vertical (longitudinal) direction inside sub-blocks and may scan in the horizontal (transverse) direction between sub-blocks in order to configure an input vector. For example, sub-blocks may be scanned in the order of indices 0, 1, 2, 4, 5, and 8. Scanning may be performed in the vertical (longitudinal) direction inside respective sub-blocks. Four samples in each of the first to fourth columns of the sub-block of index 0 may be scanned successively; four samples in each of the first to fourth columns of the sub-block of index 1 may be scanned successively; four samples in each of the first to fourth columns of the sub-block of index 2 may be scanned successively; four samples in each of the first to fourth columns of the sub-block of index 4 may be scanned successively; four samples in each the first to fourth columns of the sub-block of index 5 may be scanned successively; and four samples in each of the first to fourth columns of the sub-block of index 8 may be scanned successively.

Referring to FIG. 28B, the video signal processing device may scan in the horizontal (transverse) direction inside sub-blocks and may scan in the vertical (longitudinal) direction between sub-blocks in order to configure an input vector. For example, sub-blocks may be scanned in the order of indices 0, 4, 8, 1, 5, and 2. Scanning may be performed in the horizontal (transverse) direction inside respective sub-blocks. Four samples in each of the first to fourth rows of the sub-block of index 0 may be scanned successively; four samples in each of the first to fourth rows of the sub-block of index 4 may be scanned successively; four samples in each of the first to fourth rows of the sub-block of index 8 may be scanned successively; four samples in each of the first to fourth rows of the sub-block of index 1 may be scanned successively; four samples in each of the first to fourth rows of the sub-block of index 5 may be scanned successively; and four samples in each of the first to fourth rows of the sub-block of index 2 may be scanned successively.

If the current block's prediction mode is an intra prediction mode corresponding to an index equal to/smaller than index 34, the video signal processing device may use the scan order described with reference to FIG. 28A, and if the current block's prediction mode is an intra prediction mode corresponding to an index larger than index 34, the video signal processing device may use the scan order described with reference to FIG. 28B. In contrast, if the current block's prediction mode is an intra prediction mode corresponding to an index equal to/smaller than index 34, the video signal processing device may use the scan order described with reference to FIG. 28B, and if the current block's prediction mode is an intra prediction mode corresponding to an index larger than index 34, the video signal processing device may use the scan order described with reference to FIG. 28A.

Referring to FIG. 29A, the video signal processing device may scan in the horizontal (transverse) direction inside sub-blocks and may scan in a zigzag between sub-blocks in the order go sub-blocks of indices 0, 1, 4, 8, 5, and 2 in order to configure an input vector. For example, four samples in each of the first to fourth rows of the sub-block of index 0 may be successively scanned; four samples in each of the first to fourth rows of the sub-block of index 1 may be successively scanned; four samples in each of the first to fourth rows of the sub-block of index 4 may be successively scanned; four samples in each of the first to fourth rows of the sub-block of index 8 may be successively scanned; four samples in each of the first to fourth rows of the sub-block of index 5 may be successively scanned; and four samples in each of the first to fourth rows of the sub-block of index 2 may be successively scanned.

Referring to FIG. 29B, the video signal processing device may scan in the vertical (longitudinal) direction inside sub-blocks and may scan in a zigzag between sub-blocks in the order go sub-blocks of indices 0, 4, 1, 2, 5, and 8 in order to configure an input vector. For example, four samples in each of the first to fourth columns of the sub-block of index 0 may be successively scanned; four samples in each of the first to fourth columns of the sub-block of index 4 may be successively scanned; four samples in each of the first to fourth columns of the sub-block of index 1 may be successively scanned; four samples in each of the first to fourth columns of the sub-block of index 2 may be successively scanned; four samples in each of the first to fourth columns of the sub-block of index 5 may be successively scanned; and four samples in each of the first to fourth columns of the sub-block of index 8 may be successively scanned.

If the current block's prediction mode is an intra prediction mode corresponding to an index equal to/smaller than index 34, the video signal processing device may use the scan order described with reference to FIG. 29A, and if the current block's prediction mode is an intra prediction mode corresponding to an index larger than index 34, the video signal processing device may use the scan order described with reference to FIG. 29B. In contrast, if the current block's prediction mode is an intra prediction mode corresponding to an index equal to/smaller than index 34, the video signal processing device may use the scan order described with reference to FIG. 29B, and if the current block's prediction mode is an intra prediction mode corresponding to an index larger than index 34, the video signal processing device may use the scan order described with reference to FIG. 29A.

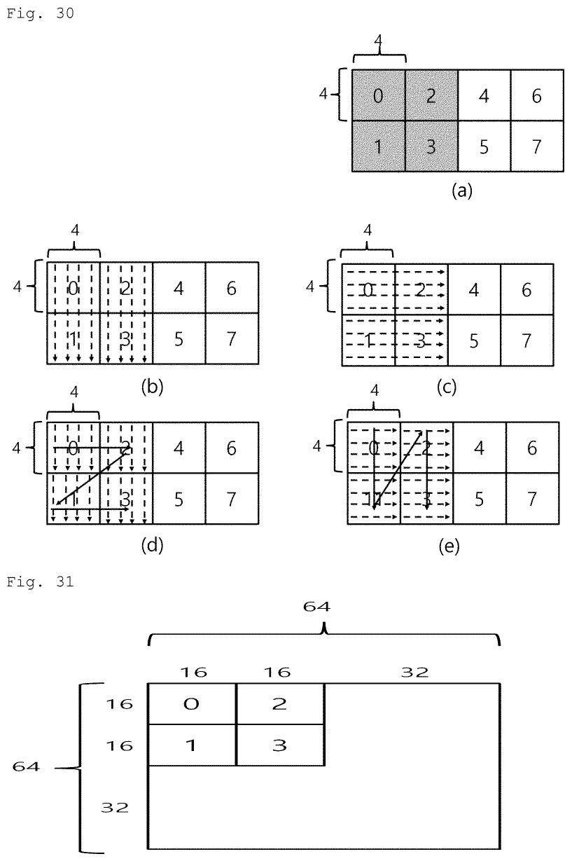

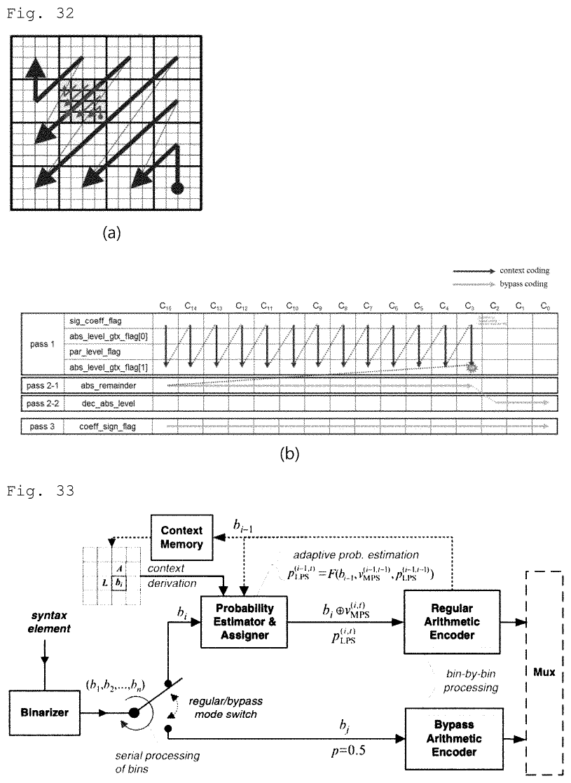

Referring to FIG. 30A, the ROI of LFNST8 may correspond to four 4×4 sub-blocks. Sub-blocks of indices 0 to 3 may correspond to the ROI. Hereinafter, a method for scanning transform coefficients for an input vector regarding LFNST8 in the ROI will be described.

Referring to FIG. 30B, the video signal processing device may use a vertical (longitudinal) direction scan order to configure an input vector. Eight samples in each of the first to fourth columns may be scanned successively in the vertical direction of sub-blocks of indices 0 and 1. In addition, eight samples in each of the fifth to eighth columns may be scanned successively in the vertical direction of sub-blocks of indices 2 and 3.

Referring to FIG. 30C, the video signal processing device may use a horizontal (transverse) direction scan order to configure an input vector. Eight samples in each of the first to fourth rows may be scanned successively in the horizontal direction of sub-blocks of indices 0 and 2. In addition, eight samples in each of the fifth to eighth rows may be scanned successively in the horizontal direction of sub-blocks of indices 1 and 3.

Referring to FIG. 30D, the video signal processing device may use a vertical (longitudinal) direction scan order inside sub-blocks and may use a horizontal (transverse) direction scan order between sub-blocks to configure an input vector. For example, sub-blocks may be scanned in the order of indices 0, 2, 1, and 3. Scanning may be performed in the vertical (longitudinal) direction inside respective sub-blocks. Four samples in each of the first to fourth columns of the sub-block of index 0 may be scanned successively; four samples in each of the first to fourth columns of the sub-block of index 2 may be scanned successively; four samples in each of the first to fourth columns of the sub-block of index 1 may be scanned successively; and four samples in each of the first to fourth columns of the sub-block of index 3 may be scanned successively.

Referring to FIG. 30E, the video signal processing device may use a horizontal (transverse) direction scan order inside sub-blocks and may use a vertical (longitudinal) direction scan order between sub-blocks to configure an input vector. For example, sub-blocks may be scanned in the order of indices 0, 1, 2, and 3. Scanning may be performed in the horizontal (transverse) direction inside respective sub-blocks. Four samples in each of the first to fourth rows of the sub-block of index 0 may be scanned successively; four samples in each of the first to fourth columns of the sub-block of index 1 may be scanned successively; four samples in each of the first to fourth columns of the sub-block of index 2 may be scanned successively; and four samples in each of the first to fourth columns of the sub-block of index 3 may be scanned successively.

A scan method may be configured by combining FIG. 30B and FIG. 30D. If the current block's prediction mode is an intra prediction mode corresponding to an index equal to/smaller than index 34, the video signal processing device may use the scan order described with reference to FIG. 30D, and if the current block's prediction mode is an intra prediction mode corresponding to an index larger than index 34, the video signal processing device may use the scan order described with reference to FIG. 30B. In contrast, if the current block's prediction mode is an intra prediction mode corresponding to an index equal to/smaller than index 34, the video signal processing device may use the scan order described with reference to FIG. 30B, and if the current block's prediction mode is an intra prediction mode corresponding to an index larger than index 34, the video signal processing device may use the scan order described with reference to FIG. 30D.

A scan method may be configured by combining FIG. 30C and FIG. 30E. If the current block's prediction mode is an intra prediction mode corresponding to an index equal to/smaller than index 34, the video signal processing device may use the scan order described with reference to FIG. 30E, and if the current block's prediction mode is an intra prediction mode corresponding to an index larger than index 34, the video signal processing device may use the scan order described with reference to FIG. 30C. In contrast, if the current block's prediction mode is an intra prediction mode corresponding to an index equal to/smaller than index 34, the video signal processing device may use the scan order described with reference to FIG. 30C, and if the current block's prediction mode is an intra prediction mode corresponding to an index larger than index 34, the video signal processing device may use the scan order described with reference to FIG. 30E.

FIG. 31 illustrates a method for applying secondary transform regarding a transform block to each sub-block according to an embodiment of the present specification.

Referring to FIG. 31, after primary transform regrading a 64×64 sized transform block, transform coefficients in the remaining area other than the 32×32 area at the left upper end may be zeroed out. The block in the 32×32 area at the left upper end may be partitioned into four 16×16 sized sub-blocks. As in FIG. 31, respective sub-blocks may be given indices 0 to 3. Secondary transform may be applied to all sub-blocks, or secondary transform may be applied to respective sub-blocks selectively/adaptively. Information regarding whether secondary transform is applied to respective sub-blocks may be included in a bitstream. That is, the decoder may parse corresponding information to identify whether secondary transform is applied to respective sub-blocks. In addition, the information regarding whether secondary transform is applied to respective sub-blocks may be derived without being included in a bitstream. For example, LFNST16 may be applied to the sub-block of index 0, and it may be determined on the basis of a reference value regarding transform coefficients of respective sub-blocks whether or not to apply second transform to the sub-blocks of indices 1 to 3. The reference value may be derived by using at least one of the number of transform coefficients, whether a transform coefficient exists in a specific position, the minimum/maximum value of transform coefficients, and the average value of transform coefficients. Sub-blocks to which secondary transform is not applied may be zeroed out.

FIG. 32 illustrates a method for scanning quantized transform coefficients and a method for entropy-coding syntax elements related to the quantized transform coefficients according to an embodiment of the present specification.

The encoder may perform residual coding with regard to a quantized signal in connection with each 4×4 sized residual sub-block. FIG. 32A illustrates a method for scanning a quantized signal in connection with each coding unit/transform unit, and a scan method in connection with each residual sub-block. FIG. 32B illustrates a method for coding quantized transform coefficients existing in a residual sub-block according to an embodiment of the present specification. One quantized transform coefficient may be separated into multiple syntaxes and re-expressed accordingly. The multiple syntaxes may be configured by using at least one of a flag syntax indicating whether a quantized transform coefficient exists or not, flag syntaxes indicating sizes, a syntax indicating a residual size, and a flag indicating a sign. The flag indicating the sign of a quantized transform coefficient among the same may be coeff_sign_flag. The coeff_sign_flag may be bypass-coded. In the present specification, the term “flag” may be used interchangeably with a syntax or a syntax element.

The decoder may decode multiple quantized transform coefficients in the decoder in the order of entropy encoding by the encoder. The decoder may use the same scanning order as the scanning order used in the encoding process.

FIG. 33 illustrates an entropy coding unit of a video signal processing device according to an embodiment of the present specification.

FIG. 33 may be used to describe the entropy coding unit 160 in FIG. 1 in more detail. The entropy coding unit may perform a binarization process and may code syntax elements included in a syntax structure by using context coding (regular arithmetic encoder) or bypass coding (bypass arithmetic encoder).

The probability value regarding context-coded syntax elements may be changed on the basis of a syntax model. The probability value regarding “0” or “1” of bypass-coded syntax elements may be equally 0.5 regardless of the syntax model. The context coding refers to an entropy coding method performed on the basis of probabilities. Therefore, there is an advantageous effect in that the coding efficiency is improved if the value of a coded syntax element can be predicted with a high probability under a specific condition. On the other hand, the bypass coding refers to a coding method performed with the same probability. Therefore, there is an advantageous effect in terms of the coding speed compared with the context coding. It is difficult to probabilistically predict the sign flag (coeff_sign_flag) regarding quantized transform coefficients due to random characteristics of respective quantized transform coefficients. Hereinafter, a coding method which uses context coding, instead of bypass coding, for coeff_sign_flag will be described.

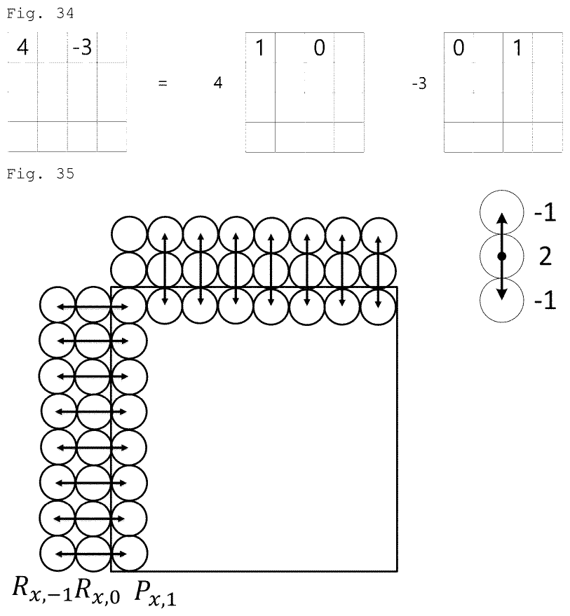

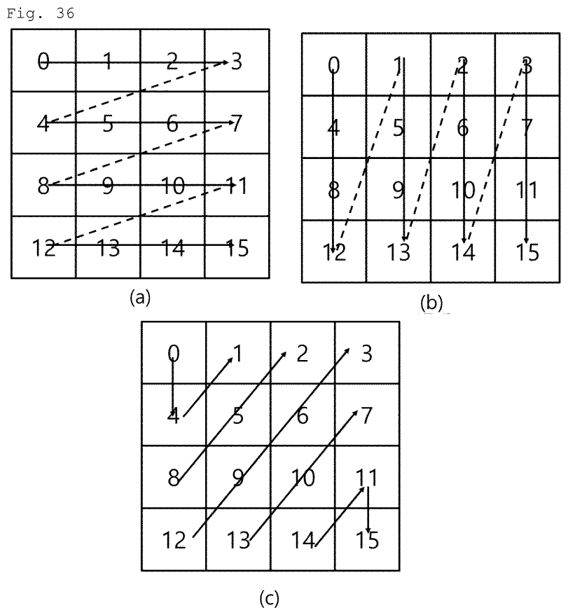

FIG. 34 illustrates a method for predicting the sign of a quantized transform coefficient.

There may exist a quantized transform coefficient group including two quantized transform coefficients. There may be four possible combinations of the sign of two quantized transform coefficients in the quantized transform coefficient group as follows: (+, +), (+, −), (−, +), and (−, −).

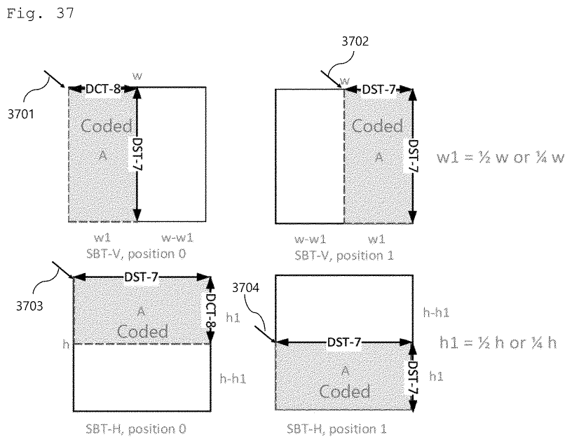

The encoder may reconstruct the quantized transform coefficient group through de-quantization and inverse transform with regard to each of the four combinations, and may determine an optimal combination on the basis of the cost of each reconstructed quantized transform coefficient group. The inverse transform process may be skipped, and the cost may be calculated by using FIG. 35 and Equation 4. The optimal combination may correspond to the minimum cost. The encoder may consider the optimal combination as a predictor and may context-code a one-bit sized indicator indicating whether the result of prediction based on the predictor is identical to the actual sign. The decoder may parse the indicator on the basis of a preconfigured context model value, thereby determining the sign of the residual signal. The maximum allowable number of sign prediction of quantized transform coefficients may be a preconfigured value, which may be 8. In addition, the encoder may acquire a bitstream including information regarding the maximum allowable number of sign prediction of quantized transform coefficients. The information regarding the sign prediction number may be signaled at the level of a sequence parameter set (SPS), a picture parameter set (PPS), a picture header (PH), a slice header, or a tile header. That is, the decoder may parse the information regarding the sign prediction number and use the same to reconstruct the current block.

FIG. 35 illustrates a cost calculating method according to an embodiment of the present specification.

Specifically, FIG. 35 illustrates a method for calculating the discontinuity of already-constructed upper and left neighbor block (sample) values of the current block (sample) and upper and left neighbor block (sample) values of the current block. The cost for combination selection described with reference to FIG. 34 may be calculated by Equation 4 below:

$$[ Equation 4 ]$$

$$cost = {\sum }_{x = 0}^{w} \vert ( - {R}_{x , - 1} + 2 {R}_{x , 0} - {P}_{x , 1} ) - {r}_{x , 1} \vert + {\sum }_{y = o}^{h} \vert ( - {R}_{- 1 , y} + 2 {R}_{0 , y} - {P}_{1 , y} ) - {r}_{1 , y} \vert$$

In Equation 4, R may refer to the value of an already-reconstructed neighbor block (sample) of the current block, P may refer to the value of the current block (sample), and r may refer to the value of a residual block (sample). w may refer to the width of the current block, and h may refer to the height of the current block. Subscripts of R, P, and r may be sample positions (for example, coordinate values). In order to reduce the implementation complexity, (−R₋₁+2*R₀−P₁) may be calculated only once, and calculation regarding multiple candidates may be performed with regard to only the current residual block that is changed. In order to reduce the complexity of sign prediction regarding multiple transform coefficients existing in the current residual block, quantization and transform may be performed after separating the multiple transform coefficients into respective transform coefficients. In this regard, r may refer to the value of a residual block regarding one separated transform coefficient. In addition, although Equation 4 is described as using three samples (sample R_{x,0}, and one left sample and one right sample with reference to R_{x,0}), two samples (sample R_{x,0} and one right sample with reference to R_{x,0}) may be used to reduce complexity. Alternatively, four samples (sample R_{x,0}, and two left and right samples with reference to R_{x,0}) may be used to improve the performance.

FIG. 36 illustrates a scan method for predicting the sign of a quantized transform coefficient according to an embodiment of the present specification.

The area in which sign prediction of a quantized transform coefficient is applied may be performed within a preconfigured range. The preconfigured range may be a 4×4 sized area including the left upper end (0,0) of the current block. The maximum allowed number of sign prediction of quantized transform coefficients may be a preconfigured value, which may be 8. Although it will be assumed in the following description that the preconfigured value is 8, this is only for convenience of description and is not limitative.

FIG. 36A illustrates a horizontal direction scan (raster scan) method. For example, for the purpose of sign prediction of quantized transform coefficients, the video signal processing device may scan rightward starting from the sample at the left upper end of a 4×4 sized residual coding block, may scan rightward from the left sample in the next row, and may repeat this process. Sign prediction may be performed the maximum allowed number of 8 times in this manner.

FIG. 36B illustrates a vertical direction scan method. For example, for the purpose of sign prediction of quantized transform coefficients, the video signal processing device may scan downward starting from the sample at the left upper end of a 4×4 sized residual coding block, may scan downward from the upper sample in the next column, and may repeat this process. Sign prediction may be performed the maximum allowed number of 8 times in this manner.

FIG. 36C illustrates a diagonal direction scan (raster scan) method. For example, for the purpose of sign prediction of quantized transform coefficients, the video signal processing device may scan diagonally toward the right upper side starting from the sample at the left upper end of a 4×4 sized residual coding block. Sign prediction may be performed the maximum allowed number of 8 times in this manner.

In the method for predicting the sign of a quantized transform coefficient, the size of the quantized transform coefficient may have a large influence on the magnitude of the residual signal generated after inverse transform, and may have a larger influence if the sign is inaccurate. Therefore, the following method may be considered in connection with performing sign prediction the maximum allowed number of times.

If the current block's prediction mode is an intra prediction mode, the scan method may be determined on the basis of the intra prediction mode (angle mode). That is, one of vertical, horizontal, and diagonal direction scans may be determined as the scan method on the basis of the intra prediction mode. If the current block's prediction mode is an intra prediction mode corresponding to an index equal to/smaller than index 34, the video signal processing device may use the vertical direction scan method. In the case of the intra prediction mode corresponding to an index equal to/smaller than index 34, the magnitude of the residual signal may decrease from the current block's left column toward the right column, and if the vertical direction scan method is used, scan is possible from relatively large quantized transform coefficients. If the current block's prediction mode is an intra prediction mode corresponding to an index larger than index 34, the horizontal direction scan method may be used. In the case of the intra prediction mode corresponding to an index larger than index 34, the magnitude of the residual signal may decrease from the current block's first row toward the lower row, and if the horizontal direction scan method is used, scan is possible from relatively large quantized transform coefficients. In contrast, if the current block's prediction mode is an intra prediction mode corresponding to an index equal to/smaller than index 34, the horizontal direction scan method may be used, and if the current block's prediction mode is an intra prediction mode corresponding to an index larger than index 34, the vertical direction scan method may be used. In addition, if the current block's prediction mode is a planar mode, a DC mode, a MIP mode, a CCLM mode, or an inter mode, the diagonal direction scan method may be used. In addition, if the current block's prediction mode is a CIIP mode, the scan method may be determined on the basis of the intra prediction mode used to predict the intra block.

If the current block's prediction mode is an inter prediction mode, the scan method may be determined on the basis of mts_idx and/or lfnst_idx. That is, since the distribution of the residual signal varies according to the type of transform method, the scan method may vary according to the transform type. For example, if the transform type derived from mts_Idx is a DCT2 transform type, the horizontal scan method may be applied. Alternatively, if the transform type derived from mts_Idx is a DST7 transform type, a backward scan method may be applied from the right lower end of the block. The backward scan method may be a scan method in the backward order in FIG. 36B or the backward order in FIG. 36C.

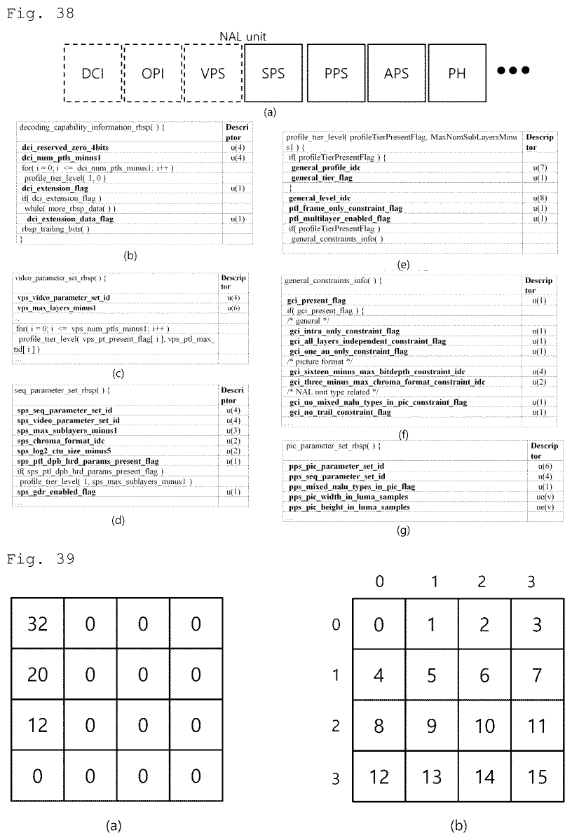

FIG. 37 illustrates a method for configuring an area for sign prediction of a quantized transform coefficient in connection with a block to which sub-block transform is applied according to an embodiment of the present specification.

Sub-block transform (SBT) refers to a transform method for a coding unit (block) to which an inter prediction mode is applied. Referring to FIG. 37, transform may be applied only to the gray-shaded portion, and the transform coefficient of other areas may be configured as 0. Therefore, transform coefficients and quantized transform coefficients may exist only in the area to which transform is applied. A syntax element related to SBT may be included in a bitstream, and the decoder may parse the syntax element related to SBT, thereby acquiring the area in which quantized transform coefficients exist. The syntax element related to SBT may include Cu_sbt_flag indicating whether SBT is applied, cu_sbt_quat_flag indicating the partitioning ratio (1:3/3:1 or 1:2/2:1) of the area to which SBT is applied, cu_sbt_horizontal_flag indicating the partitioning direction, and cu_sbt_pos_flag indicating the area to which SBT is applied. Referring to FIG. 37, for types to which SBT is applied are illustrated. Arrows 3701, 3702, 3703, and 3704 in FIG. 37 indicate the position in which sign prediction of quantized transform coefficients is started in respective types. That is, the starting position may be the sample at the left upper end of the area to which transform is applied. In contrast, the starting position may be the sample at the right upper end of the area to which transform is applied, or a place at which quantized transform coefficients will occur with high frequencies. At least one of the transverse and longitudinal sizes of the area to which SBT is applied may be smaller than 4, depending on the partitioning method. Then, the video signal processing device may perform sign prediction of quantized transform coefficients by transforming the area so as to have a size larger than 4.

FIG. 38 illustrates the structure of a high-level syntax according to an embodiment of the present specification.

A bitstream is encapsulated by using a network abstraction layer (NAL) unit as a basic unit. That is, the bitstream may include at least one network abstraction layer (NAL) unit. Referring to FIG. 38A, the NAL unit may include decoding capability information (DCI), raw byte sequence payload (RBSP), operation point information (OPI) RBSP, video parameter set (VPS) RBSP, sequence parameter set (SPS) RBSP, picture parameter set (PPS) RBSP, adaption parameter set (APS) RBSP, and picture Header (PH) in this order. The DCI RBSP, OPI RBSP, and VPS RBSP indicated by dotted lines may be selectively signaled.

FIG. 38B illustrates the structure of DCI RBSP, FIG. 38C illustrates the structure of VPS RBSP, and FIG. 38D illustrates the structure of SPS RBSP. FIG. 38E illustrates the structure of PTL (profile_tier_level) including a video sequence's profile, tier, and level information. FIG. 38F illustrates the structure of general constraints information (GCI). FIG. 38G illustrates the structure of PPS RBSP. Raw byte sequence payload (RBSP) may refer to a syntax which is byte-aligned and encapsulated as a NAL unit. The syntax element included in GCI (GCI syntax element) may control tools and/or functions or the like included in the GCI and/or other syntax structures (for example, syntax structure of VPS RBSP, SPS RBSP syntax structure, PPS RBSP syntax structure, and the like) to be disabled for the sake of interoperability. If the GCI syntax element instructs tools and/or functions or the like to be disabled, tools and/or functions declared in the lower syntax may be disabled. The position of the NAL unit parsed by the decoder may determine whether tools and/or functions or the like disabled by the GCI syntax element will be applied to the entire bitstream or to a part thereof. PTL may be included in DCI RBSP, VPS RBSP, or SPS RBSP and signaled. GCI may be included in PTL and signaled.

The SPS RBSP may include a flag (sps_coeff_sign_pred_enabled_flag) indicating whether sign prediction of a quantized transform coefficient is enabled. The value of sps_coeff_sign_pred_enabled_flag, if 1, may mean that sign prediction of a quantized transform coefficient is enabled inside CLVS, and the value of sps_coeff_sign_pred_enabled_flag, if 0, may mean that sign prediction of a quantized transform coefficient is not enabled inside CLVS. The GCI may include a flag (gci_no_coeff_sign_pred_constraint_flag) constraining whether sps_coeff_sign_pred_enabled_flag is enabled or not. The value of gci_no_coeff_sign_pred_constraint_flag, if 1, may mean that the value of sps_coeff_sign_pred_enabled_flag regarding all pictures inside OlsInScope is 0, and the value of gci_no_coeff_sign_pred_constraint_flag, if 0, may mean that there is no constraint regarding the value of sps_coeff_sign_pred_enabled_flag. OlsInScope may refer to all layers included in all bitstreams.

If the value of sps_coeff_sign_pred_enabled_flag indicates that sign prediction of transform coefficients is enabled, the maximum allowed number of sign prediction of transform coefficients may be configured in new parameter MaxCoeffSignPred. If the value of sps_coeff_sign_pred_enabled_flag indicates that sign prediction of transform coefficients is enabled, MaxCoeffSignPred may be signaled/parsed.

The maximum allowed number of sign prediction of quantized transform coefficients may be determined adaptively. For example, the maximum allowed number may be independently determined and applied with regard to each unit such as a coding unit, a coding tree block, a sliced, a sub-picture, or a picture on the basis of the quantization parameter (QP) value, the current block's size, the current block's color component (whether luma component or chroma component), whether LFNST is applied to the current block, or the quantized coefficient level. Hereinafter, a method for adaptively determining the maximum allowed number will be described.
a. The maximum allowed number may be determined on the basis of the QP value. For example, a preconfigured value and the QP value may be compared such that, if the QP value is larger, the maximum allowed number may become smaller than a preconfigured allowed number. This is because, if the QP value is larger, the QP step's size may increase, and the size of the quantized transform coefficient tends to decrease. The maximum allowed number may be reduced by a pre-promised value, and the pre-promised value may be an integer of 1 or larger. On the other hand, if the QP value is larger than the preconfigured value, the maximum allowed number may become smaller than a preconfigured allowed number.
b. The maximum allowed number may be determined on the basis of the current block's size. For example, a preconfigured value and the current block's size may be compared such that, if the block's size is larger, the maximum allowed number may become smaller than a preconfigured allowed number. This is because, in the case of a block having a size larger than the preconfigured value, residual signal distribution may be uniform, and the transform coefficient may have a substantially large or small size. The maximum allowed number may be reduced by a pre-promised value, and the pre-promised value may be an integer of 1 or larger. On the other hand, if the current block's size is larger than the preconfigured value, the maximum allowed number may become smaller than a preconfigured allowed number.
c. The maximum allowed number may be determined on the basis of the current block's color component. That is, the maximum allowed number may be determined according to whether the current block is a luma component block or a chroma component block. for example, if the current block is a luma component block, a preconfigured maximum allowed number may be used, and if the current block is a chroma component block, preconfigured maximum allowed number may be reduced. The maximum allowed number when the current block is a chroma component block may be determined on the basis of the maximum allowed number when the current block is a luma component block, and may become smaller than the maximum allowed number when the current block is a luma component block by a pre-promised value. The pre-promised value may be an integer of 1 or larger. On the other hand, if the current block is a chroma component block, a preconfigured maximum allowed number may be used, and if the current block is a luma component block, preconfigured maximum allowed number may be reduced.
d. The maximum allowed number may be determined on the basis of whether LFNST is applied to the current block. For example, the maximum allowed number when LFNST is applied to the current block may be smaller than that when LFNST is not applied. The maximum allowed number when LFNST is applied to the current block may become smaller than a preconfigured maximum allowed number by a pre-promised value. This is because quantized transform coefficients of a block to which LFNST is applied have a higher compression efficiency than a block to which LFNST is not applied. The pre-promised value may be an integer of 1 or larger. On the other hand, if LFNST is not applied to the current block, the maximum allowed number may be reduced.
e. The maximum allowed number may be determined on the basis of quantized transform coefficients. For example, the maximum allowed number may be determined on the basis of one of the average value of quantized transform coefficients of the current block, the maximum value, and the median value thereof. For example, the average value (or maximum value or median value) may be compared with an arbitrary value such that, if the average value is smaller, the maximum allowed number may be smaller than a preconfigured maximum allowed number. On the other hand, the average value (or maximum value or median value) may be compared with an arbitrary value such that, if the arbitrary value is larger than or equal to the average value, the maximum allowed number may be smaller than a preconfigured maximum allowed number.

Whether the above-described methods a to e are applied may be determined on the basis of an arbitrary value. For example, if the initially configured maximum allowed number (that is, before methods a to e are applied) is equal to or larger than (or smaller than) an arbitrary value, quantized transform coefficient sign prediction may not be performed, and information regarding quantized transform coefficient sign prediction may be coded through bypass coding.

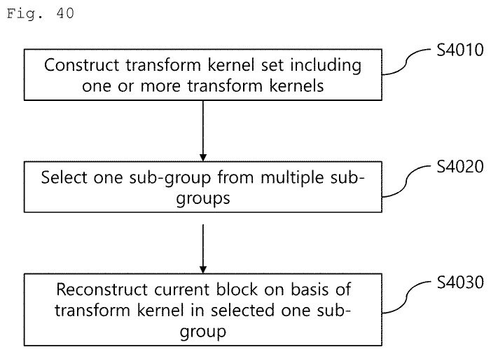

FIG. 39 illustrates a context model regarding syntax elements related to transform coefficient signs of the present specification.

In a quantized transform coefficient sign prediction method, coeff_sign_flag may be context-coded on the basis of a context model. The context model of coeff_sign_flag will now be described.

The context model may be modeled on the basis of whether the size of the first scanned quantized transform coefficient is larger than/equal to a specific value or smaller than the same. In addition, context model may be modeled on the basis of a size comparison between the first scanned quantized transform coefficient and other quantized transform coefficients. For example, referring to FIG. 39A, the first quantized transform coefficient in the scan order may have a value of 32, the second quantized transform coefficient may have a value of 20, and the third quantized transform coefficient may have a value of 12. The video signal processing device may compare the first quantized transform coefficient value and a specific value, thereby generating the context model of coeff_sign_flag. The video signal processing device may compare each of the second quantized transform coefficient value and the third quantized transform coefficient value with the first quantized transform coefficient, thereby generating the context model of coeff_sign_flag.

The video signal processing device may generate the context model of coeff_sign_flag on the basis of the position (for example, coordinate value) of a scanned quantized transform coefficient. For example, assuming that the horizontal axis in FIG. 39B denotes the x coordinate, and the vertical axis denotes the y coordinate, a 4×4 sized block may be expressed by coordinate values of (0, 0) to (3, 3). In this regard, contextId may be calculated as follows:

$$contextId = ( x \&\& y ) ? 1 : 0 ,$$

$$contextId = ( x + y ) \%2 ? 1 : 0 ,$$

$$contextId = ( x > 0 \&\& y > 0 ) ? 1 : 0$$

FIG. 40 illustrates a video signal processing method according to an embodiment of the present specification.

FIG. 40 is a flowchart of methods described with reference to FIG. 1 to FIG. 39.

FIG. 40, the video signal processing device may configure a transform kernel set including one or more transform kernels (S4010). The one or more transform kernels in the transform kernel set may be grouped into multiple sub-groups. Each of the multiple sub-groups may include the one or more transform kernels. In addition, the video signal processing device may select one sub-group from the multiple sub-groups (S4020). In addition, the video signal processing device may reconstruct the current block on the basis of a transform kernel in the selected sub-group (S4030).

The one sub-group may be selected on the basis of a parameter related to the current block's residual signal.

The parameter related to the residual signal may be determined on the basis of the sum of the current block's transform coefficients.

The parameter related to the residual signal may be determined on the basis of the position of the lastly scanned transform coefficient in the scan order among the current block's transform coefficients.

The parameter related to the residual signal may be determined on the basis of the sum of quantization parameters of the current block's transform coefficients.

The parameter related to the residual signal may be determined on the basis of the distribution of quantization level signals of the current block's transform coefficients.

The distribution of quantization level signals may be determined on the basis of at least one of the deviation, average, and variance of the current block's transform coefficients.

The current block may be reconstructed on the basis of a transform kernel corresponding to the smallest cost among costs regarding one or more transform kernels in the one selected sub-group, respectively. The cost may be a value related to the degree of similarity between the current block and a reconstructed signal which is reconstructed by using each of one or more transform kernels in the one sub-group.

The one or more transform kernels may be kernels for low frequency non-separable transform (LFNST). A method for scanning an input vector for the LFNST may be determined on the basis of the current block's prediction mode. The scanning method may be one of horizontal scan, vertical scan, and diagonal scan.

In addition, the video signal processing device may determine whether or not to predict the sign of transform coefficients of the current block on the basis of the result of parsing a first syntax element included in a sequence parameter set. If the parsing result indicates that the sign of transform coefficients of the current block is to be predicted, the current block may be reconstructed on the basis of the predicted sign and a transform kernel of a selected sub-group.

A scan method for predicting the sign of transform coefficients of the current block may be one of horizontal scan, vertical scan, and diagonal scan.

The value of the first syntax element (the third syntax element) may be constrained on the basis of a second syntax element which is a general constraint information (GCI) syntax element. If the second syntax element has a value of 1, the value of the first syntax element may be configured as 0, which indicates that sign prediction regarding transform coefficients of the current block is not to be performed, regardless of the result of parsing the first syntax element. If the second syntax element has a value of 0, the value of the first syntax element may not be constrained.

The above methods(video signal processing methods) described in the present specification may be performed by a processor in a decoder or an encoder. Furthermore, the encoder may generate a bitstream that is decoded by a video signal processing method. Furthermore, the bitstream generated by the encoder may be stored in a computer-readable non-transitory storage medium (recording medium).

The present specification has been described primarily from the perspective of a decoder, but may function equally in an encoder. The term “parsing” in the present specification has been described in terms of the process of obtaining information from a bitstream, but in terms of the encoder, may be interpreted as configuring the information in a bitstream. Thus, the term “parsing” is not limited to operations of the decoder, but may also be interpreted as the act of configuring a bitstream in the encoder. Furthermore, the bitstream may be configured to be stored in a computer-readable recording medium.

The above-described embodiments of the present invention may be implemented through various means. For example, embodiments of the present invention may be implemented by hardware, firmware, software, or a combination thereof.

For implementation by hardware, the method according to embodiments of the present invention may be implemented by one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, and the like.

In the case of implementation by firmware or software, the method according to embodiments of the present invention may be implemented in the form of a module, procedure, or function that performs the functions or operations described above. The software code may be stored in memory and driven by a processor. The memory may be located inside or outside the processor, and may exchange data with the processor by various means already known.

Some embodiments may also be implemented in the form of a recording medium including computer-executable instructions such as a program module that is executed by a computer. Computer-readable media may be any available media that may be accessed by a computer, and may include all volatile, nonvolatile, removable, and non-removable media. In addition, the computer-readable media may include both computer storage media and communication media. The computer storage media include all volatile, nonvolatile, removable, and non-removable media implemented in any method or technology for storing information such as computer-readable instructions, data structures, program modules, or other data. Typically, the communication media include computer-readable instructions, other data of modulated data signals such as data structures or program modules, or other transmission mechanisms, and include any information transfer media.

The above-mentioned description of the present invention is for illustrative purposes only, and it will be understood that those of ordinary skill in the art to which the present invention belongs may make changes to the present invention without altering the technical ideas or essential characteristics of the present invention and the invention may be easily modified in other specific forms. Therefore, the embodiments described above are illustrative and are not restricted in all aspects. For example, each component described as a single entity may be distributed and implemented, and likewise, components described as being distributed may also be implemented in an associated fashion.

The scope of the present invention is defined by the appended claims rather than the above detailed description, and all changes or modifications derived from the meaning and range of the appended claims and equivalents thereof are to be interpreted as being included within the scope of present invention.

1-20. (canceled)

21. A video signal decoding device comprising a processor,
wherein the processor is configured to:
construct a transform kernel set comprising one or more transform kernels,
wherein the one or more transform kernels in the transform kernel set are grouped into multiple sub-groups,
wherein each of the multiple sub-groups comprises the one or more transform kernels,
select one sub-group among the multiple sub-groups, and
reconstruct a current block based on a transform kernel in the one sub-group,
wherein the one sub-group is determined based on a condition related to transform coefficients of the current block.

22. The video signal decoding device of claim 21,
wherein the condition related to the transform coefficients of the current block includes a condition for an absolute value of a sum of the transform coefficients of the current block.

23. The video signal decoding device of claim 22,
wherein the one sub-group is determined by comparing the absolute value with a first threshold and/or a second threshold.

24. The video signal decoding device of claim 22,
wherein when the absolute value is less than or equal to the first threshold, a number of a transform kernel included in the one sub-group is 1.

25. The video signal decoding device of claim 22,
wherein when the absolute value is greater than the first threshold and the absolute value is less than or equal to the second threshold, a number of a transform kernel included in the one sub-group is 4.

26. The video signal decoding device of claim 22,
wherein when the absolute value is greater than the second threshold, a number of a transform kernel included in the one sub-group is 6.

27. The video signal decoding device of claim 22,
wherein the first threshold is 6, and the second threshold is 32.

28. The video signal decoding device of claim 21, wherein the processor is configured to:
determine whether or not to predict signs of transform coefficients of the current block on the basis of the result of parsing a first syntax element included in a sequence parameter set, and
wherein when the parsing result indicates that signs of transform coefficients of the current block are to be predicted, the current block is reconstructed on the basis of the predicted signs and a transform kernel in selected one sub-group.

29. The video signal decoding device of claim 28, wherein a scan method for predicting signs of transform coefficients of the current block is one of horizontal scan, vertical scan, and diagonal scan.

30. The video signal decoding device of claim 28, wherein the value of the first syntax element is constrained by a second syntax element which is a general constraint information (GCI) syntax element,
wherein when the second syntax element has a value of 1, the value of the first syntax element is configured as 0, which indicates that sign prediction regarding transform coefficients of the current block is not to be performed, regardless of the result of parsing the first syntax element, and
wherein when the second syntax element has a value of 0, the value of the first syntax element is not constrained.

31. A video signal encoding device comprising a processor,
wherein the processor is configured to obtain a bitstream decoded by a decoding method,
wherein the decoding method comprises:
constructing a transform kernel set comprising one or more transform kernels,
wherein the one or more transform kernels in the transform kernel set are grouped into multiple sub-groups,
wherein each of the multiple sub-groups comprises the one or more transform kernels;
selecting one sub-group among the multiple sub-groups; and
reconstructing a current block based on a transform kernel in the one sub-group,
wherein the one sub-group is determined based on a condition related to transform coefficients of the current block.

32. The video signal encoding device of claim 31,
wherein the condition related to the transform coefficients of the current block includes a condition for an absolute value of a sum of the transform coefficients of the current block.

33. The video signal encoding device of claim 32,
wherein the one sub-group is determined by comparing the absolute value with a first threshold and/or a second threshold.

34. The video signal encoding device of claim 32,
wherein when the absolute value is less than or equal to the first threshold, a number of a transform kernel included in the one sub-group is 1.

35. The video signal encoding device of claim 32,
wherein when the absolute value is greater than the first threshold and the absolute value is less than or equal to the second threshold, a number of a transform kernel included in the one sub-group is 4.

36. The video signal encoding device of claim 32,
wherein when the absolute value is greater than the second threshold, a number of a transform kernel included in the one sub-group is 6.

37. The video signal encoding device of claim 32,
wherein the first threshold is 6, and the second threshold is 32.

38. The video signal encoding device of claim 21, wherein the decoding method further comprises:
determining whether or not to predict signs of transform coefficients of the current block on the basis of the result of parsing a first syntax element included in a sequence parameter set, and
wherein when the parsing result indicates that signs of transform coefficients of the current block are to be predicted, the current block is reconstructed on the basis of the predicted signs and a transform kernel in the one sub-group.

39. The video signal encoding device of claim 38, wherein a scan method for predicting signs of transform coefficients of the current block is one of horizontal scan, vertical scan, and diagonal scan.

40. A computer-readable non-transitory storage medium configured to store a bitstream, the bitstream being decoded by a decoding method,
wherein the decoding method comprises:
constructing a transform kernel set comprising one or more transform kernels,
wherein the one or more transform kernels in the transform kernel set are grouped into multiple sub-groups,
wherein each of the multiple sub-groups comprises the one or more transform kernels;
selecting one sub-group among the multiple sub-groups; and
reconstructing a current block based on a transform kernel in the one sub-group,
wherein the one sub-group is determined based on a condition related to transform coefficients of the current block.
